(19) United States
(12) Patent Application Publication
(10) Pub. No.: US 2026/0105504 A1
(43) Pub. Date: Apr. 16, 2026

(54) PRODUCT DESCRIPTION GENERATION WITH MACHINE LEARNING

(71) Applicant: CVS PHARMACY, INC., WOONSOCKET, RI (US)

(72) Inventors: Astha Puri, Jersey City, NJ (US); Sarah Jamila Boukhris-Escandon, San Antonio, TX (US); William Scott Daniel Ferguson, Wolfeboro, NH (US)

(21) Appl. No.: 19/354,483

(22) Filed: Oct. 9, 2025

Related U.S. Application Data
(60) Provisional application No. 63/705,751, filed on Oct. 10, 2024.

(51) Int. Cl. G06Q 30/0601; G06N 20/00

(52) U.S. Cl. CPC G06Q 30/0623; G06N 20/00

(57) ABSTRACT

A system can include one or more memory devices storing instructions thereon that, when executed by one or more processors, can cause the one or more processors to retrieve information for a product of an entity, determine that the information includes proprietary information associated with the product or the entity, modify the information to remove the proprietary information from the information, input the modified information into a machine learning model, and generate a second description of the product using the modified information.

### CROSS-REFERENCE TO RELATED PATENT APPLICATIONS

This application claims the benefit of and priority to U.S. Provisional Ser. No. 63/705,751, filed Oct. 10, 2024, the entirety of which is incorporated by reference herein.

### BACKGROUND

Publicly accessible information may include descriptions of one or more products.

### SUMMARY

At least one embodiment relates to a system. The system can include one or more memory devices. The one or more memory devices can store instructions thereon. The instructions can, when executed by one or more processors, cause the one or more processors to retrieve information for a product of an entity. The information can include a first description of the product. The instructions can cause the one or more processors to determine, based on an evaluation of the information, that the information includes proprietary information associated with the product or the entity. The instructions can cause the one or more processors to modify the information to remove the proprietary information from the information. The instructions can cause the one or more processors to input the modified information into a machine learning model. The instructions can cause the one or more processors to generate, using the machine learning model, a second description of the product using the modified information. The machine learning model can generate the second description to conform with one or more characteristics.

In some embodiments, the product can correspond to a first product type. The instructions can cause the one or more processors to store, responsive to generation of the second description of the product, the second description of the product in a database that corresponds to the first product type. The instructions can cause the one or more processors to detect, based on one or more interactions with a user interface, an association between the one or more interactions and the first product type. The instructions can cause the one or more processors to cause, responsive to detection of the association, the second description of the product to be included in the user interface.

In some embodiments, the machine learning model can include a first machine learning model and a second machine learning model. The instructions can cause the one or more processors to provide, to the first machine learning model, a prompt to generate the second description of the product using the first description of the product. The instructions can cause the one or more processors to generate, using the first machine learning model, the second description of the product. The instructions can cause the one or more processors to provide, responsive to generation of the second description of the product, the first description of the product and the second description of the product to the second machine learning model to cause the second machine learning model to generate a score to indicate correlations between the first description of the product and the second description of the product.

In some embodiments, the instructions can cause the one or more processors to determine that the score is below a predetermined threshold. The instructions can cause the one or more processors to provide the first description of the product and the second description of the product for manual review to receive one or more adjustments to the second description of the product. The instructions can cause the one or more processors to retrain, responsive to receipt of the one or more adjustments, the machine learning model for subsequent description generation.

In some embodiments, the instructions can cause the one or more processors to evaluate the one or more adjustments to determine whether to approve the second description of the product. The instructions can cause the one or more processors to approve, responsive to evaluation of the one or more adjustments, the second description of the product.

In some embodiments, the scores can include a first score to indicate the correlations between the first description of the product and the second description of the product and a second score to indicate a performance of the machine learning model. The instructions can cause the one or more processors to evaluate the first score and the second score to determine whether to provide the second description for manual review. The instructions can cause the one or more processors to determine, responsive to evaluation of the first score and the second score, to provide the second description for manual review.

In some embodiments, a first prompt and the first description of the product can be provided to the machine learning model to cause the machine learning model to generate the second description of the product. The instructions can cause the one or more processors to provide, responsive to generation of the second description of the product, a second prompt to cause the machine learning model to generate a score to indicate correlations between the first description of the product and the second description of the product.

In some embodiments, the instructions can cause the one or more processors to provide, to the machine learning model, a prompt to indicate a display format of the second description of the product. The instructions can cause the one or more processors to determine, responsive to generation of the second description of the product, that the second description of the product conforms to the display format. The instructions can cause the one or more processors to transmit, to a display device, one or more signals to cause the display device to display the second description of the product in the display format.

In some embodiments, the instructions can cause the one or more processors to determine, responsive to an evaluation of the second description of the product, that an amount of information included in the second description of the product is below a predetermined threshold. The instructions can cause the one or more processors to extract, from an image of the product, a plurality of information that corresponds to the product. The instructions can cause the one or more processors to generate, using the machine learning model, a third description of the product based at least one the plurality of information and the second description of the product.

In some embodiments, the instructions can cause the one or more processors to provide, to the machine learning model, a prompt to indicate a context of the second description of the product. The instructions can cause the one or more processors to generate, using the machine learning model, the second description of the product based on at least a portion of the modified information and the context of the second description of the product.

In some embodiments, the instructions can cause the one or more processors to retrieve, from a database, a second plurality of information that corresponds to a plurality of products of the entity. The second plurality of information can include a plurality of descriptions of the plurality of products. The instructions can cause the one or more processors to input, responsive to retrieval of the second plurality of information, into the machine learning model, at least a portion of the second plurality of information. The instructions can cause the one or more processors to generate, using the machine learning model, a second plurality of descriptions of the plurality of products. The instructions can cause the one or more processors to determine, using the machine learning model or a second machine learning model, scores for the second plurality of descriptions to indicate a performance of the machine learning model with respect to generation of the second plurality of descriptions.

In some embodiments, the instructions can cause the one or more processors to detect, responsive to evaluation of the scores for the second plurality of descriptions, a subset of descriptions of the second plurality of descriptions for which the scores are below a predetermined threshold. The instructions can cause the one or more processors to provide the subset of descriptions for human review.

In some embodiments, the instructions can cause the one or more processors to transmit, responsive to generation of the second description of the product, one or more signals to cause a display device to display a user interface that provides the second description of the product.

The instructions can cause the one or more processors to receive, via the user interface, one or more inputs to indicate a performance of the machine learning model with respect to generation of the second description of the product. The instructions can cause the one or more processors to retrain, based at least on the one or more inputs, the machine learning model for subsequent generation of one or more descriptions.

At least one embodiment relates to a system. The system can include one or more memory devices. The one or more memory devices can store instructions thereon. The instructions can, when executed by one or more processors, cause the one or more processors to receive, via a user interface, a selection of a product, the product having a first category and a description. The instructions can cause the one or more processors to determine, based on a query of a database, a status of the product. The instructions can cause the one or more processors to retrieve, based on the status of the product, a plurality of descriptions of a plurality of products, the plurality of products having the first category. The instructions can cause the one or more processors to provide, to a machine learning (ML) model, the plurality of descriptions and the description of the product to cause the ML model to generate one or more outputs that represent correlations between the product and one or more products of the plurality of products. The instructions can cause the one or more processors to identify, based on the one or more outputs, the one or more products of the plurality of products. The instructions can cause the one or more processors to provide, via the user interface, a recommendation to replace the product with the one or more products of the plurality of products.

In some embodiments, the instructions can cause the one or more processors to receive, via the user interface, a selection of a given product of the one or more products. The instructions can cause the one or more processors to provide, responsive to receipt of the selection, via the user interface, a prompt to provide feedback regarding the recommendation. The instructions can cause the one or more processors to retrain, based on the feedback regarding the recommendation, the ML model for subsequent generation of one or more second outputs.

In some embodiments, the one or more products can include a first description of the plurality of descriptions. The instructions can cause the one or more processors to display, via the user interface, a graphical representation of the recommendation. The graphical representation of the recommendation can include a first element to provide the description of the product, a second element to provide the first description of the plurality of descriptions, and a third element to select a given product of the one or more products. The instructions can cause the one or more processors to receive, via the user interface, a selection of the given product of the one or more products. The instructions can cause the one or more processors to update, responsive to receipt of the selection, the user interface to include a prompt to provide feedback regarding the recommendation.

In some embodiments, the instructions can cause the one or more processors to provide, to a display device, one or more signals to cause the display device to display the user interface. The instructions can cause the one or more processors to receive, from the display device, one or more indications of interactions with the user interface. The interactions can represent the selection of the product. The instructions can cause the one or more processors to provide, responsive to determination of the status of the product, via the user interface, a prompt to provide the recommendation. The instructions can cause the one or more processors to retrieve, responsive to receipt of an indication to provide the recommendation, the plurality of descriptions of a plurality of products.

In some embodiments, the user interface can, prior to generation of the one or more outputs, include a graphical representation to identify the product. The instructions can cause the one or more processors to update the user interface to reflect identification of the one or more products by replacing the graphical representation to identify the product with one or more graphical representations to identify the one or more products.

In some embodiments, the instructions can cause the one or more processors to receive, via the user interface, a selection of a given product of the one or more products. The instructions can cause the one or more processors to update, responsive to receipt of the selection, a status of the given product to reflect selection of the given product. The instructions can cause the one or more processors to prevent, responsive to the update of the status of the given product, subsequent retrieval of a description of the given product.

At least one embodiment relates to a system. The system can include one or more memory devices. The one or more memory devices can store instructions thereon. The instructions can, when executed by one or more processors, cause the one or more processors to retrieve information for a product of an entity, the information comprising a first description of the product. The instructions can cause the one or more processors to determine, based on an evaluation of the information, that the information includes proprietary information associated with the product or the entity. The instructions can cause the one or more processors to modify the information to remove the proprietary information from the information. The instructions can cause the one or more processors to input the modified information into a machine learning model. The instructions can cause the one or more processors to generate, using the machine learning model, a second description of the product using the modified information, the machine learning model configured to generate the second description to conform with one or more characteristics.

In some embodiments, the product can correspond to a first product type. The instructions can cause the one or more processors to store, responsive to generation of the second description of the product, the second description of the product in a database that corresponds to the first product type. The instructions can cause the one or more processors to detect, based on one or more interactions with a user interface, an association between the one or more interactions and the first product type. The instructions can cause the one or more processors to cause, responsive to detection of the association, the second description of the product to be included in the user interface.

In some embodiments, the machine learning model can include a first machine learning model and a second machine learning model. The instructions can cause the one or more processors to provide, to the first machine learning model, a prompt to generate the second description of the product using the first description of the product. The instructions can cause the one or more processors to generate, using the first machine learning model, the second description of the product. The instructions can cause the one or more processors to provide, responsive to generation of the second description of the product, the first description of the product and the second description of the product to the second machine learning model to cause the second machine learning model to generate a score to indicate correlations between the first description of the product and the second description of the product.

In some embodiments, the instructions can cause the one or more processors to determine that the score is below a predetermined threshold. The instructions can cause the one or more processors to provide the first description of the product and the second description of the product for manual review to receive one or more adjustments to the second description of the product. The instructions can cause the one or more processors to retrain, responsive to receipt of the one or more adjustments, the machine learning model for subsequent description generation.

In some embodiments, the instructions can cause the one or more processors to evaluate the one or more adjustments to determine whether to approve the second description of the product. The instructions can cause the one or more processors to approve, responsive to evaluation of the one or more adjustments, the second description of the product.

In some embodiments, the score can include a first score to indicate the correlations between the first description of the product and the second description of the product and a second score to indicate a performance of the machine learning model. The instructions can cause the one or more processors to evaluate the first score and the second score to determine whether to provide the second description for manual review. The instructions can cause the one or more processors to determine, responsive to evaluation of the first score and the second score, to provide the second description for manual review.

In some embodiments, a first prompt and the first description of the product can be provided to the machine learning model to cause the machine learning model to generate the second description of the product. The instructions can cause the one or more processors to provide, responsive to generation of the second description of the product, a second prompt to cause the machine learning model to generate a score to indicate correlations between the first description of the product and the second description of the product.

In some embodiments, the instructions can cause the one or more processors to provide, to the machine learning model, a prompt to indicate a display format of the second description of the product. The instructions can cause the one or more processors to determine, responsive to generation of the second description of the product, that the second description of the product conforms to the display format. The instructions can cause the one or more processors to transmit, to a display device, one or more signals to cause the display device to display the second description of the product in the display format.

In some embodiments, the instructions can cause the one or more processors to determine, responsive to an evaluation of the second description of the product, that an amount of information included in the second description of the product is below a predetermined threshold. The instructions can cause the one or more processors to extract, from an image of the product, a plurality of information that corresponds to the product. The instructions can cause the one or more processors to generate, using the machine learning model, a third description of the product based at least one the plurality of information and the second description of the product.

In some embodiments, the instructions can cause the one or more processors to provide, to the machine learning model, a prompt to indicate a context of the second description of the product. The instructions can cause the one or more processors to generate, using the machine learning model, the second description of the product based on at least a portion of the modified information and the context of the second description of the product.

In some embodiments, the instructions can cause the one or more processors to retrieve, from a database, a second plurality of information that corresponds to a plurality of products of the entity. The second plurality of information can include a plurality of descriptions of the plurality of products. The instructions can cause the one or more processors to input, responsive to retrieval of the second plurality of information, into the machine learning model, at least a portion of the second plurality of information. The instructions can cause the one or more processors to generate, using the machine learning model, a second plurality of descriptions of the plurality of products. The instructions can cause the one or more processors to determine, using the machine learning model or a second machine learning model, scores for the second plurality of descriptions to indicate a performance of the machine learning model with respect to generation of the second plurality of descriptions.

In some embodiments, the instructions can cause the one or more processors to detect, responsive to evaluation of the scores for the second plurality of descriptions, a subset of descriptions of the second plurality of descriptions for which the scores are below a predetermined threshold. The instructions can cause the one or more processors to provide the subset of descriptions for human review.

The instructions can cause the one or more processors to transmit, responsive to generation of the second description of the product, one or more signals to cause a display device to display a user interface that provides the second description of the product. The instructions can cause the one or more processors to receive, via the user interface, one or more inputs to indicate a performance of the machine learning model with respect to generation of the second description of the product. The instructions can cause the one or more processors to retrain, based at least on the one or more inputs, the machine learning model for subsequent generation of one or more descriptions.

At least one embodiment relates to a method. The method can include retrieving, by one or more processing circuits, information for a product of an entity, the information comprising a first description of the product. The method can include determining, by the one or more processing circuits, based on an evaluation of the information, that the information includes proprietary information associated with the product or the entity. The method can include modifying, by the one or more processing circuits, the information to remove the proprietary information from the information. The method can include inputting, by the one or more processing circuits, the modified information into a machine learning model. The method can include generating, by the one or more processing circuits, using the machine learning model, a second description of the product using the modified information, the machine learning model configured to generate the second description to conform with one or more characteristics.

In some embodiments, the product can correspond to a first product type. The method can include storing, by the one or more processing circuits, responsive to generating the second description of the product, the second description of the product in a database that corresponds to the first product type. The method can include detecting, by the one or more processing circuits, based on one or more interactions with a user interface, an association between the one or more interactions and the first product type. The method can include causing, by the one or more processing circuits, responsive to detecting the association, the second description of the product to be included in the user interface.

In some embodiments, the machine learning model can include a first machine learning model and a second machine learning model. The method can include providing, by the one or more processing circuits, to the first machine learning model, a prompt to generate the second description of the product using the first description of the product. The method can include generating, by the one or more processing circuits, using the first machine learning model, the second description of the product. The method can include providing, by the one or more processing circuits, responsive to generating the second description of the product, the first description of the product and the second description of the product to the second machine learning model to cause the second machine learning model to generate a score to indicate correlations between the first description of the product and the second description of the product.

In some embodiments, a first prompt and the first description of the product can be provided to the machine learning model to cause the machine learning model to generate the second description of the product. The method can include providing, by the one or more processing circuits, responsive to generating the second description of the product, a second prompt to cause the machine learning model to generate a score to indicate correlations between the first description of the product and the second description of the product.

In some embodiments, the method can include providing, by the one or more processing circuits, to the machine learning model, a prompt to indicate a display format of the second description of the product. The method can include determining, by the one or more processing circuits, responsive to generating the second description of the product, that the second description of the product conforms to the display format. The method can include transmitting, by the one or more processing circuits, to a display device, one or more signals to cause the display device to display the second description of the product in the display format.

In some embodiments, the method can include determining, by the one or more processing circuits, responsive to an evaluation of the second description of the product, that an amount of information included in the second description of the product is below a predetermined threshold. The method can include extracting, by the one or more processing circuits, from an image of the product, a plurality of information that corresponds to the product. The method can include generating, by the one or more processing circuits, using the machine learning model, a third description of the product based at least one the plurality of information and the second description of the product.

At least one embodiment relates to one or more non-transitory computer-readable storage media. The one or more non-transitory computer-readable storage media can store instructions thereon. The instructions can, when executed by one or more processors, cause the one or more processors to perform operations. The operations can include retrieving information for a product of an entity, the information comprising a first description of the product. The operations can include determining, based on an evaluation of the information, that the information includes proprietary information associated with the product or the entity. The operations can include modifying the information to remove the proprietary information from the information. The operations can include inputting the modified information into a machine learning model. The operations can include generating, using the machine learning model, a second description of the product using the modified information, the machine learning model configured to generate the second description to conform with one or more characteristics.

At least one embodiment relates to a system. The system can include one or more memory devices. The one or more memory devices can store instructions thereon. The instructions can, when executed by one or more processors, cause the one or more processors to receive, via a user interface, a selection of a product, the product having a first category and a description. The instructions can cause the one or more processors to determine, based on a query of a database, a status of the product. The instructions can cause the one or more processors to retrieve, based on the status of the product, a plurality of descriptions of a plurality of products, the plurality of products having the first category. The instructions can cause the one or more processors to provide, to a machine learning (ML) model, the plurality of descriptions and the description of the product to cause the ML model to generate one or more outputs that represent correlations between the product and one or more products of the plurality of products. The instructions can cause the one or more processors to identify, based on the one or more outputs, the one or more products of the plurality of products. The instructions can cause the one or more processors to provide, via the user interface, a recommendation to replace the product with the one or more products of the plurality of products.

In some embodiments, the instructions can cause the one or more processors to receive, via the user interface, a selection of a given product of the one or more products. The instructions can cause the one or more processors to provide, responsive to receipt of the selection, via the user interface, a prompt to provide feedback regarding the recommendation. The instructions can cause the one or more processors to retrain, based on the feedback regarding the recommendation, the ML model for subsequent generation of one or more second outputs.

In some embodiments, the one or more products can have a first description of the plurality of descriptions. The instructions can cause the one or more processors to display, via the user interface, a graphical representation of the recommendation. The graphical representation of the recommendation can include a first element to provide the description of the product, a second element to provide the first description of the plurality of descriptions, and a third element to select a given product of the one or more products. The instructions can cause the one or more processors to receive, via the user interface, a selection of the given product of the one or more products. The instructions can cause the one or more processors to update, responsive to receipt of the selection, the user interface to include a prompt to provide feedback regarding the recommendation.

In some embodiments, the instructions can cause the one or more processors to provide, to a display device, one or more signals to cause the display device to display the user interface. The instructions can cause the one or more processors to receive, from the display device, one or more indications of interactions with the user interface, the interactions representing the selection of the product. The instructions can cause the one or more processors to provide, responsive to determination of the status of the product, via the user interface, a prompt to provide the recommendation. The instructions can cause the one or more processors to retrieve, responsive to receipt of an indication to provide the recommendation, the plurality of descriptions of the plurality of products.

In some embodiments, the user interface, prior to generation of the one or more outputs, can include a graphical representation to identify the product. The instructions can cause the one or more processors to update the user interface to reflect identification of the one or more products by replacing the graphical representation to identify the product with one or more graphical representations to identify the one or more products.

In some embodiments, the instructions can cause the one or more processors to receive, via the user interface, a selection of a given product of the one or more products. The instructions can cause the one or more processors to update, responsive to receipt of the selection, a status of the given product to reflect selection of the given product. The instructions can cause the one or more processors to prevent, responsive to the update of the status of the given product, subsequent retrieval of a description of the given product.

In some embodiments, the instructions can cause the one or more processors to retrieve one or more sets of data associated with respective products of the plurality of products. The instructions can cause the one or more processors to provide the one or more sets of data to the ML model to cause the ML model to generate the plurality of descriptions. The instructions can cause the one or more processors to store the plurality of descriptions in a database.

In some embodiments, the one or more sets of data can include textual strings. Generation of the plurality of descriptions can include the ML model to remove at least one textual string from the textual strings based on a context of the at least one textual string and output the plurality of descriptions in accordance with one or more rules that dictate an arrangement or a structure for the plurality of descriptions.

At least one embodiment relates to a method. The method can include receiving, by one or more processing circuits, via a user interface, a selection of a product, the product having a first category and a description. The method can include determining, by the one or more processing circuits, based on a query of a database, a status of the product. The method can include retrieving, by the one or more processing circuits, based on the status of the product, a plurality of descriptions of a plurality of products. The plurality of products can have the first category. The method can include providing, by the one or more processing circuits, to a machine learning (ML) model, the plurality of descriptions and the description of the product to cause the ML model to generate one or more outputs that represent correlations between the product and one or more products of the plurality of products. The method can include identifying, by the one or more processing circuits, based on the one or more outputs, the one or more products of the plurality of products. The method can include providing, by the one or more processing circuits, via the user interface, a recommendation to replace the product with the one or more products of the plurality of products.

In some embodiments, the method can include receiving, by the one or more processing circuits, via the user interface, a selection of a given product of the one or more products. The method can include providing, by the one or more processing circuits, responsive to receiving the selection, via the user interface, a prompt to provide feedback regarding the recommendation. The method can include retraining, by the one or more processing circuits, based on the feedback regarding the recommendation, the ML model for subsequent generation of one or more second outputs.

In some embodiments, the one or more products can have a first description of the plurality of descriptions. The method can include displaying, by the one or more processing circuits, via the user interface, a graphical representation of the recommendation. The graphical representation of the recommendation can include a first element to provide the description of the product, a second element to provide the first description of the plurality of descriptions, and a third element to select a given product of the one or more products. The method can include receiving, by the one or more processing circuits, via the user interface, a selection of the given product of the one or more products. The method can include updating, by the one or more processing circuits, responsive to receiving the selection, the user interface to include a prompt to provide feedback regarding the recommendation.

In some embodiments, the method can include providing, by the one or more processing circuits, to a display device, one or more signals to cause the display device to display the user interface. The method can include receiving, by the one or more processing circuits, from the display device, one or more indications of interactions with the user interface, the interactions representing the selection of the product. The method can include providing, by the one or more processing circuits, responsive to determining the status of the product, via the user interface, a prompt to provide the recommendation. The method can include retrieving, by the one or more processing circuits, responsive to receiving an indication to provide the recommendation, the plurality of descriptions of the plurality of products.

In some embodiments, the user interface, prior to generation of the one or more outputs, can include a graphical representation to identify the product. The method can include updating, by the one or more processing circuits, the user interface to reflect identification of the one or more products by replacing the graphical representation to identify the product with one or more graphical representations to identify the one or more products.

In some embodiments, the method can include receiving, by the one or more processing circuits, via the user interface, a selection of a given product of the one or more products. The method can include updating, by the one or more processing circuits, responsive to receiving the selection, a status of the given product to reflect selection of the given product. The method can include preventing, by the one or more processing circuits, responsive to updating the status of the given product, subsequent retrieval of a description of the given product.

In some embodiments, the method can include retrieving, by the one or more processing circuits, one or more sets of data associated with respective products of the plurality of products. The method can include providing, by the one or more processing circuits, the one or more sets of data to the ML model to cause the ML model to generate the plurality of descriptions. The method can include storing, by the one or more processing circuits, the plurality of descriptions in a database.

In some embodiments, the one or more sets of data can include textual strings. Generation of the plurality of descriptions can include the ML model to remove at least one textual string from the textual strings based on a context of the at least one textual string and output the plurality of descriptions in accordance with one or more rules that dictate an arrangement or a structure for the plurality of descriptions.

At least one embodiment relates to one or more non-transitory computer-readable storage media. The one or more non-transitory computer-readable storage media can store instructions thereon. The instructions can, when executed by one or more processors, cause the one or more processors to perform operations. The operations can include receiving, via a user interface, a selection of a product, the product having a first category and a description. The operations can include determining, based on a query of a database, a status of the product. The operations can include retrieving, based on the status of the product, a plurality of descriptions of a plurality of products, the plurality of products having the first category. The operations can include providing, to a machine learning (ML) model, the plurality of descriptions and the description of the product to cause the ML model to generate one or more outputs that represent correlations between the product and one or more products of the plurality of products. The operations can include identifying, based on the one or more outputs, the one or more products of the plurality of products. The operations can include providing, via the user interface, a recommendation to replace the product with the one or more products of the plurality of products.

In some embodiments, the operations can include receiving, via the user interface, a selection of a given product of the one or more products. The operations can include providing, responsive to receiving the selection, via the user interface, a prompt to provide feedback regarding the recommendation. The operations can include retraining, based on the feedback regarding the recommendation, the ML model for subsequent generation of one or more second outputs.

In some embodiments, the one or more products can have a first description of the plurality of descriptions. The operations can include displaying, via the user interface, a graphical representation of the recommendation. The graphical representation of the recommendation can include a first element to provide the description of the product, a second element to provide the first description of the plurality of descriptions, and a third element to select a given product of the one or more products. The operations can include receiving, via the user interface, a selection of the given product of the one or more products. The operations can include updating, responsive to receiving the selection, the user interface to include a prompt to provide feedback regarding the recommendation.

In some embodiments, the operations can include providing, to a display device, one or more signals to cause the display device to display the user interface. The operations can include receiving, from the display device, one or more indications of interactions with the user interface, the interactions representing the selection of the product. The operations can include providing, responsive to determining the status of the product, via the user interface, a prompt to provide the recommendation. The operations can include retrieving, responsive to receiving an indication to provide the recommendation, the plurality of descriptions of the plurality of products.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a system to generate descriptions of one or more products, according to some embodiments.

FIG. 2 is a workflow illustrating communication between one or more components of the system illustrated in FIG. 1, according to some embodiments.

FIG. 3 is a workflow illustrating communication between one or more components of the system illustrated in FIG. 1, according to some embodiments.

FIG. 4 is an illustration of information provided to a machine learning (ML) model and information output by the ML model, according to some embodiments.

FIG. 5 is a graph including scores of one or more descriptions generated by a machine learning (ML) model, according to some embodiments.

FIG. 6A is a flow diagram of a method to generate descriptions of one or more products, according to some embodiments.

FIG. 6B is a flow chart of a method to evaluate descriptions generated by one or more models, according to some embodiments.

FIG. 7 is a sequence diagram of a method to provide recommendations regarding one or more products, according to some embodiments.

FIG. 8 is a flow chart of a method to evaluate outputs generated by a machine learning (ML) model, according to some embodiments.

FIG. 9 is a flow diagram of a method to provide recommendations regarding one or more products, according to some embodiments.

### DETAILED DESCRIPTION

Referring generally to the FIGURES, systems and methods for product description generation is described herein. Product description generation may refer to and/or include generating information that describes and/or explains one or more products. For example, product description generation may include generating a description of a product posted on an online forum (e.g., website, blog, social media post, product release, etc.). It should be understood that various embodiments of the present disclosure may be utilized to generate descriptions for products that are associated with, provided by, and/or otherwise linked to one or more entities. For example, a first product may be produced by a manufacturer (e.g., a first entity) and listed on a website of a store (e.g., a second entity). Further, while the present disclosure discusses product description generation for products associated with health and wellness as one possible use case or implementation space, it should be understood that the various features and embodiments described herein are equally applicable to product description generation for various types of products other than health and wellness. As one example, in some implementations, the features and embodiments described herein may be utilized to generate descriptions for products such as automobiles, travel destinations, and/or food and beverage.

Publicly accessible information (e.g., websites, online forums, social media, blogs, etc.) may include information that describes products. For example, a listing on a website for shampoo (e.g., a product) may include information that describes the shampoo. In this example, the information may include descriptions, such as bottle size, scent, application directions, product line, and/or associated products. However, publicly accessible information associated with products may include propriety information for the products (e.g., trademarks, slogans, copyrights, etc.). Moreover, publicly accessible information may be arranged and/or configured in a given format (e.g., paragraphs, bullet points, highlights, etc.).

Depending on the publicly accessible information, inputting the information into a machine learning model may result in capturing portions of the information that may not assist with selecting given products. For example, if the publicly accessible information includes several propriety slogans (in the description) that output of a machine learning model may also include the slogans. In this example, descriptions that simply reproduced slogans may not assist in filtering and/or narrowing potential products. As another example, publicly accessible information may be generic and/or simple. In this example, the publicly accessible information may include a product name and/or product type. To continue this example, the generic and/or simple information may not provide enough information for a machine learning model to generate a description of the product.

Some technical solutions of the present disclosure include implementation of machine learning (ML) models to generate descriptions of products based on scrubbed and/or modified versions of publicly accessible information. The implementation of ML models to generate descriptions can reduce latency between description generation and posting of the descriptions as ML models can generate descriptions with reduced or no manual input. For example, a ML model may generate a description of a product based on a single prompt. Additionally, ML models may generate descriptions at a rapid rate which further reduces latency between an input to generate a description and the generation of the description. While ML models excel at generating information (e.g., descriptions), the ML models may struggle to select given information to publish. As such, information generated by ML models may await manual approval and/or manual modification prior to publishing the information.

The manual approval process can become quite time extensive. For example, a ML model may generate 50,000 descriptions for manual review and approval. In this example, if each description requires 3 minutes for review and approval, the 50,000 descriptions would require over 2,500 to review the descriptions. The present disclosure describes some evaluation techniques to evaluate and/or score outputs (e.g., generated descriptions) to restrict and/or reduce the amount and/or number of generated descriptions that await manual intervention (e.g., manual review, manual adjustments, etc.). For example, ML models may be prompted to generate a reference-based metric to compare human generated product descriptions with product descriptions generated by ML models. The reference-based metrics may be used to filter and/or restrict which descriptions are forwarded for human review. For example, the reference-based metrics may reduce the number of descriptions, for human review, to 500 descriptions. In this example, the 500 descriptions would require 25 hours to review, which would be a 99% reduction in the amount of time it takes to manual review the descriptions. The reference-based metrics may include at least one of bilingual evaluation understudy (BLEU) score, recall-oriented understudy for gisting evaluation (ROUGE) score, metric for evaluation of translation with explicit ordering (METEOR) score, and Bidirectional Encoder Representations from Transformers (BERT) score.

However, these example reference-based metrics require a reference (e.g., a reference description, a human generated description, etc.) to compare the descriptions generated by ML models. This requirement can reduce scaling as generated descriptions can only be evaluated when a reference description is available. Moreover, reference-based metrics may have low correlation with human judgements, such as paraphrasing, abbreviations, acronyms, etc., and may result in semantic relationships not being detected as the semantic relationships are detected based on overlap between words in the reference description and the generated description.

The present disclosure further describes some technical solutions to overcome the aforementioned limitations of reference-based metrics. For example, a reference free BERT score may be combined with a prompt-based eval score (e.g., G-eval, chain-of-thought eval, form filling paradigm, etc.) to identify descriptions that fall below a given percentile. In this examples, descriptions that fall below the given percentile may be forwarded for human review and/or evaluation. Furthermore, descriptions that have a score above the given percentile may be published and/or forwarded for distribution.

Various systems and/or methods described herein may implement ML models to generate descriptions of products to assist in selecting given products. ML models trained to generate descriptions with modified information may provide descriptions that include information to assist with product selection. For example, the ML models may be fed information that has been scrubbed and/or modified to removed slogans from the information to avoid generation of descriptions that may not assist in product selection.

Moreover, the ML models may reduce an amount of time when given products and/or product types are being search for. For example, the ML models may generate descriptions of products that may subsequently be used to match with product queries (e.g., search engine entries, website keywords, etc.). In this example, the generated descriptions may match and/or closely resemble sentiment and/or formats similar to that entered in a search bar. Additionally, the generated descriptions may be evaluated for completeness and/or accuracy prior to display.

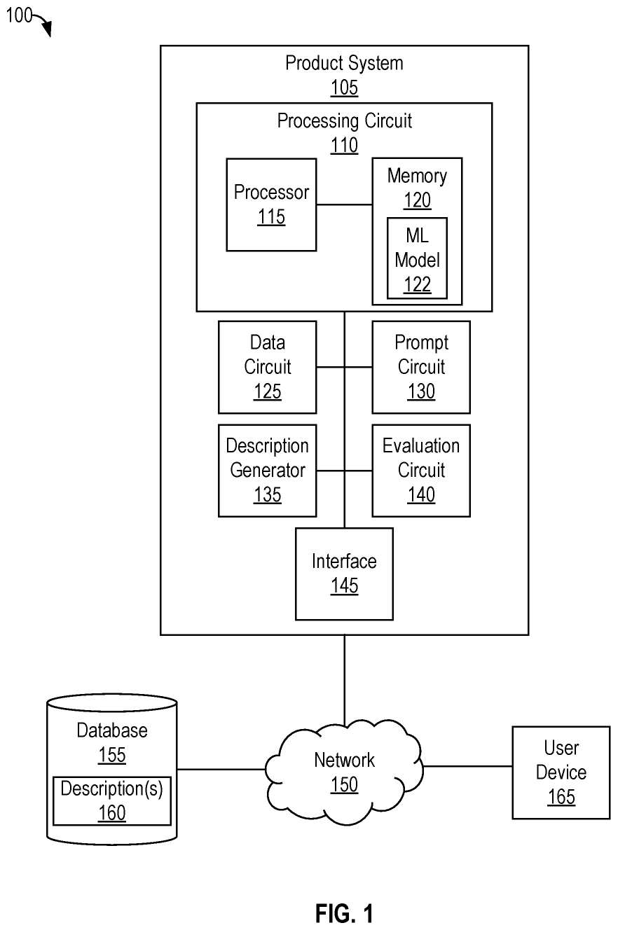

FIG. 1 depicts a block diagram of system 100, according to some embodiments. In some embodiments, the system 100 and/or one or more components thereof may implement and/or include a closed-loop system. Each system and/or component of the system 100 can include one or more processors, memory, network interfaces, communication interfaces, and/or user interfaces. Memory can store programming logic that, when executed by the processors, controls the operation of the corresponding computing system or device. Memory can also store data in databases. The network interfaces can allow the systems and/or components of the system 100 to communicate wirelessly. The communication interfaces can include wired and/or wireless communication interfaces and the systems and/or components of the system 100 can be connected via the communication interfaces. The various components of the system 100 can be implemented via hardware (e.g., circuitry), software (e.g., executable code), or any combination thereof. Systems, devices, and components in FIG. 1 can be added, deleted, integrated, separated, and/or rearranged.

In some embodiments, the system 100 may include at least one product system 105, at least one network 150, at least one database 155, and at least one user device 165. In some embodiments, the system 100 and/or one or more systems, devices, and/or components thereof may implement at least one of the various techniques, processes, operations, and/or actions described herein to generate descriptions of products.

In some embodiments, the network 150 may include at least one of a local area network (LAN), wide area network (WAN), telephone network (such as the Public Switched Telephone Network (PSTN)), Controller Area Network (CAN), wireless link, intranet, the Internet, a cellular network, and/or combinations thereof. In some embodiments, the various systems, components, and/or devices included in the system 100 may communicate with one another via the network 150.

In some embodiments, the user device 165 may perform various actions and/or access various types of information. The information may be provided over the network 150. In some embodiments, the user device 165 may perform similar functionality to that of at least one system, device, and/or component of the system 100. For example, the user device 165 may perform similar operations to that of the product system 105. In some embodiments, the user device 165 may include one or more applications to receive information, display information, and/or receive user interactions with content displayed by the user device 165.

In some embodiments, the user device 165 may include at least one of a screen, a monitor, a visual display device, a touchscreen display, a television, a video display, a liquid crystal display (LCD), a light emitting diode (LED) display, a mobile device, a kiosk, a digital terminal, a mobile computing device, a desktop computer, a smartphone, a tablet, a smart watch, a smart sensor, and/or any other device that can facilitate providing, receiving, displaying and/or otherwise interacting with content (e.g., webpages, mobile applications, etc.). For example, the user device 165 may include displays that include a resistive touchscreen that can receive user input via interactions (e.g., touches) with the touchscreen.

In some embodiments, the database 155 may include at least one of a computing device, a remote server, a server bank, a remote device, and/or among other possible computer hardware and/or computer software. For example, the database 155 may include a server bank and the server bank can store, keep, maintain, and/or otherwise hold the various types of information described herein. In some embodiments, the database 155 may house and/or otherwise implement at least one of the various systems, devices, and/or components described herein. In some embodiments, the database 155 may include, store, maintain, and/or otherwise host the product system 105. For example, the product system 105 may be distributed across one or more servers (e.g., the database 155). In some implementations, the product system 105 and/or various other components of the system 100 may be implemented using cloud computing services/platforms.

In some embodiments, the database 155 may refer to and/include at least one data source. For example, the database 155 may provide and/or include information associated with and/or corresponding to one or more products. As another example, the database 155 may provide information from a web browser, a website, a Uniform Resource Locator (URL), product labels, product images, and/or other possible types of information. In some embodiments, the database 155 may include at least one of online resources, publicly accessible information sources, Application Programming Interface (API) messages, data registries, and/or other possible sources. In some embodiments, the database 155 may provide information associated with at least one description 160. For example, the database 155 may provide information associated with a description 160 of a product listed on a website (e.g., an entity). As another example, the database 155 may provide information associated with a description 160 of a product that is available from a provider (e.g., an entity). In some embodiments, the database 155 may provide information, such as published descriptions of products, product labels, user provide descriptions, product images, product type, and/or various types of information associated with products.

In some embodiments, the product system 105 may include at least one processing circuit 110, at least one data circuit 125, at least one prompt circuit 130, at least one description generator 135, at least one evaluation circuit 140, and/or at least one interface 145. The processing circuit 110 may include at least one processor 115 and memory 120. In some embodiments, the processing circuit 110 and/or one or more components thereof (e.g., the processors 115 and memory 120) may perform similar functionality to that of the product system 105 and/or one or more components thereof. For example, memory 120 may store programming logic that, when executed by the processors 115, causes the processors 115 to perform functionality similar to that of the data circuit 125.

In some embodiments, the processing circuit 110 may be communicably connected to one or more components of the product system 105. For example, the processing circuit 110 may be communicably connected to the interface 145. In some embodiments, the processors 115 may be implemented as a general-purpose processor, an application specific integrated circuit (ASIC), one or more field programmable gate arrays (FPGAs), a group of processing components, or other suitable electronic processing components.

In some embodiments, memory 120 (e.g., memory, memory unit, memory devices, storage device, etc.) may include one or more devices (e.g., RAM, ROM, Flash memory, hard disk storage, etc.) for storing data and/or computer code for completing or facilitating the various processes, layers and modules described in the present application. Memory 120 may be or include volatile memory or non-volatile memory. Memory 120 may include one or more non-transitory computer-readable storage media. Memory 120 may include database components, object code components, script components, or any other type of information structure for supporting the various activities and information structures described in the present application. According to an exemplary embodiment, memory 120 is communicably connected to the processors 115 via the processing circuit 110 and memory 120 includes computer code for executing (e.g., by the processing circuit 110 and/or the processors 115) one or more processes described herein.

In some embodiments, memory 120 may store, keep, hold, and/or otherwise maintain at least one machine learning (ML) model 122. The ML model 122 may be trained using one or more various ML and/or Artificial Intelligence techniques. For example, the ML model 122 may be trained using supervised and/or unsupervised learning. As another example, the ML model 122 may be trained using deep learning techniques. In some embodiments, one or more components of the product system 105 may access and/or utilize the ML model 122. For example, the processors 115 may utilize the ML model 122. In some embodiments, the ML model 122 is trained to generate one or more descriptions of products described herein.

In some embodiments, the ML model 122 may refer to and/or include Generative Artificial Intelligence (GAI). In some embodiments, the ML model 122 and/or various other models described herein may be or include a large language model (LLM). For example, the ML model 122 may include a generative pre-trained transformer. In some embodiments, the generative pre-trained transformer (e.g., the ML model 122) may generate one or more descriptions 160 that were absent from training data used to train the ML model 122. For example, the generative pre-trained transformer may be trained to generate product descriptions (e.g., the descriptions 160) instead of or in addition to retrieving and/or identifying descriptions that were included in training data. In some implementations, the ML model 122 may generate new descriptions 160 that do not exist within data sources (e.g., the database 155) available to the ML model 122, regardless of whether the data was used to train the ML model 122 (e.g., may generate new, non-preexisting descriptions).

In some embodiments, the interface 145 may include at least one of network communication devices, network interfaces, and/or other possible communication interfaces.

The interface 145 may include wired or wireless communications interfaces (e.g., jacks, antennas, transmitters, receivers, transceivers, wire terminals, etc.) for conducting data communications with various systems, devices, and/or components described herein. The interface 145 may be direct (e.g., local wired or wireless communications) and/or via a communications network (e.g., the network 150). For example, the interface 145 may include an Ethernet card and port for sending and receiving data via an Ethernet-based communications link or network. The interface 145 may also include a Wi-Fi transceiver for communicating via a wireless communications network (e.g., the network 150). The interface 145 may include a power line communications interface. The interface 145 may include an Ethernet interface, a USB interface, a serial communications interface, and/or a parallel communications interface.

In some embodiments, the product system 105 may generate, produce, provide, and/or otherwise display at least one user interface. For example, the product system 105 may display at least one Graphical User Interface. In some embodiments, the product system 105 may transmit one or more signals that cause one or more devices to display a user interface. For example, the interface 145 may transmit signals, to the user device 165, that cause the user device 165 to display a user interface.

In some embodiments, the data circuit 125 may retrieve one or more sets of information. For example, the data circuit 125 may transmit one or more Application Programming Interface (API) calls to retrieve the information. In some embodiments, the data circuit 125 may retrieve the information from a database. For example, the data circuit 125 may retrieve information from the database 155. In some embodiments, the data circuit 125 may retrieve information that corresponds to at least product. For example, the data circuit 125 may retrieve information that corresponds to a pill container (e.g., a product). As another example, the data circuit 125 may retrieve information that corresponds to an Over the Counter (OTC) medication (e.g., a product).

In some embodiments, the information may refer to and/or include the descriptions 160. For example, the data circuit 125 may retrieve information that includes and/or indicates the descriptions 160. In some embodiments, the data circuit 125 may retrieve the information in one or more formats. For example, the descriptions 160 may include a collection of textual strings. As another example, the descriptions 160 may include sentences and/or paragraphs.

In some embodiments, the data circuit 125 may evaluate the information based on a set of rules. For example, the data circuit 125 may check for propriety information (e.g., slogans, trademarks, copyrights, etc.) in the information retrieved from the database 155. As another example, the data circuit 125 may include and/or perform operations similar to a data scrapper. In some embodiments, the database 155 may store and/or maintain indications of propriety information. For example, the database 155 may store a list of slogans associated with a plurality of products. To continue this example, the descriptions 160 of the plurality of products may be linked to the list of slogans.

In some embodiments, the data circuit 125 may determine that one or more sets of information includes propriety information. For example, the data circuit 125 may detect matches between one or more strings included in the descriptions 160 and the list of slogans stored by the database 155. As another example, the data circuit 125 may perform sentence comparisons to determine that descriptions 160 include propriety information.

In some embodiments, the data circuit 125 may modify the information. For example, the data circuit 125 may remove the propriety information from the descriptions 160. As another example, the data circuit 125 may include a data cleanser that can scrub and/or remove the propriety information from the descriptions 160. In some embodiments, the data circuit 125 may reevaluate the information to confirm that the propriety information was removed from the descriptions 160.

In some embodiments, the data circuit 125 may forward and/or otherwise provide information (e.g., the descriptions 160) without first modifying, adjusting, and/or altering the information. For example, the data circuit 125 may serve a data retriever and then forwards and/or provides retrieved data that includes the original content of the retrieved data.

In some embodiments, the data circuit 125 may forward and/or provide the descriptions 160 to one or more components of the system 100. For example, the data circuit 125 may forward the descriptions 160 to the description generator 135. In some embodiments, the data circuit 125 may forward the descriptions 160 responsive to modification of the information and/or the descriptions 160. For example, the data circuit 125 may forward the descriptions 160 responsive to removing proprietary information from the descriptions 160. In some embodiments, and as described herein, the data circuit 125 may forward the descriptions 160 without first modifying and/or altering the descriptions 160.

In some embodiments, the description generator 135 may input the descriptions 160 into at least one machine learning (ML) model. For example, the description generator 135 may input the descriptions 160 into the ML model 122. In some embodiments, the description generator 135 may input the descriptions 160 into the ML model 122 as one or more constraints and/or parameters for the ML model 122. In other embodiments, the description generator 135 may provide the descriptions 160 as one or more inputs to the ML model 122.

In some embodiments, the description generator 135 may generate one or more descriptions of at least one product. For example, the description generator 135 may utilize and/or otherwise control the ML model 122 to generate one or more descriptions based on inputting the descriptions 160 into the ML model 122. As another example, the ML model 122 may generate the descriptions based on correlations between the descriptions 160 that were input into the model.

In some embodiments, the description generator 135 may input, into the ML model 122, one or more first descriptions 160. For example, the description generator 135 may input first descriptions 160, that were retrieved from the database 155, into the ML model 122. To continue this example, the ML model 122 may generate one or more second descriptions 160 based on the first descriptions 160 provided as inputs to the ML model 122.

In some embodiments, the ML model 122 may generate one or more descriptions that were not included training data that was used to train the ML model 122. For example, the ML model 122 may generate predictions instead of retrieving previous descriptions from a database. Stated otherwise, the ML model 122 may be trained to generate and/or produce second descriptions 160 instead of outputting descriptions that were used to train the ML model 122.

In some embodiments, the ML model 122 may provide the second descriptions 160 (e.g., descriptions generated by the ML model 122) to the data circuit 125. For example, the data circuit 125 may receive the second descriptions 160 responsive to generation of the second descriptions 160. In some embodiments, the data circuit 125 may transmit, via the interface 145, one or more signals to cause a display device to display a user interface. For example, the data circuit 125 may transmit one or more signals to the user device 165 to cause the user device 165 to display a user interface. In some embodiments, the data circuit 125 may cause a display device to display a user interface that includes the second descriptions 160. For example, the user interface may include, present, and/or otherwise display the second descriptions 160. In some embodiments, the data circuit 125 may provide and/or otherwise indicate the descriptions 160 by at least one of an audible output, a voice assistant, or a recited message.

In some embodiments, the data circuit 125 may receive one or more inputs. For example, the data circuit 125 may receive inputs via the user interface (e.g., selections, data inputs, icon selection, scores, etc.). As another example, the data circuit 125 may receive inputs from the user device 165. In some embodiments, the inputs may indicate a performance of the ML model 122. For example, the inputs may include scores for one or more second descriptions generated by the ML model 122. As another example, the inputs may include indications of one or more aspects of the second descriptions that exceed predetermined criteria and/or indications of one or more aspects of the second descriptions that are below predetermined criteria.

In some embodiments, the inputs may indicate adjustments and/or changes to a format and/or arrangement of the second descriptions. For example, the ML model 122 may have generated descriptions in bullet form and the inputs may indicate that the descriptions be in paragraph form. As another example, the inputs may indicate that a number of characters, sentences, and/or paragraphs are less than a predetermined number.

In some embodiments, the data circuit 125 may provide the inputs to the evaluation circuit 140. For example, the data circuit 125 may forward the inputs to the evaluation circuit 140 as a semi-continuous stream based on receipt of the inputs from the user device 165. In some embodiments, the evaluation circuit 140 may determine, based on the inputs, a performance of the ML model 122. For example, the evaluation circuit 140 may determine given descriptions (e.g., subsets) that exceed one or more thresholds. As another example, the evaluation circuit 140 may determine given descriptions (e.g., subsets) that are below the thresholds. In some embodiments, the evaluation circuit 140 may retrain the ML model 122. For example, the evaluation circuit 140 may retrain the ML model 122 to generate descriptions in paragraph form responsive to inputs providing an indication to generate the descriptions in paragraph form. As another example, the evaluation circuit 140 may retrain the ML model 122 to prevent the ML model 122 from generating descriptions that include certain words and/or phrases.

In some embodiments, the evaluation circuit 140 may determine that one or more aspects of the descriptions are below a predetermined threshold. For example, the evaluation circuit 140 may determine that a given description, generated by the ML model 122, includes a word count below a given threshold. In some embodiments, the descriptions provided to the ML model 122 may be simplistic and/or generic (e.g., few words, brief, etc.). As a result, the ML model 122 may generate descriptions that are also brief. In some embodiments, the evaluation circuit 140 may flagged descriptions that are below certain thresholds. The evaluation circuit 140 may forward the flagged descriptions to the data circuit 125.

In some embodiments, the data circuit 125 may perform subsequent and/or additional data scraping based on the flagged descriptions. For example, the data circuit 125 may perform Optical Character Recognition (OCR) on images of products associated with the flagged descriptions. As another example, the data circuit 125 may extract information from a label (e.g., an image of a product) to supplement the descriptions provided to the ML model 122. In some embodiments, the data circuit 125 may provide subsequent data (e.g., scrapped data) to the ML model 122 to cause the ML model 122 to update and/or generate one or more descriptions.

In some embodiments, the products described herein may correspond to at least one product type. For example, shampoo (e.g., a product) may correspond to hygiene (e.g., a product type) and/or hair care (e.g., a second product type). As another example, a pill container (e.g., a product) may correspond to storage (e.g., a product type) and/or medication (e.g., a second product type). In some embodiments, the data circuit 125 may store descriptions generated by the ML model 122 in one or more databases based on product type. For example, the data circuit 125 may store, in the database 155, one or more descriptions that corresponds to hair care (e.g., product type). To continue this example, the data circuit 125 may link and/or otherwise associated the one or more descriptions with one another based on the descriptions corresponding to hair care. Stated otherwise, a subsequent query, of the database 155, for descriptions of hair products would result in retrieval of the one or more descriptions corresponding to hair care.

In some embodiments, the data circuit 125 may detect associations between interactions and product types. For example, the data circuit 125 may receive, from the user device 165, one or more search parameters (e.g., interactions) and/or keywords (e.g., interactions) provided by a user. In some embodiments, the data circuit 125 may detect associations responsive to determining that the interactions correspond to one or more product types. For example, a search parameter may include “hair product,” “hair routine,” and/or “hair care. ” In this example, the data circuit 125 may detect associations between the interactions and product types based on interactions provided by the user device 165.

In some embodiments, the data circuit 125 may cause one or more user interfaces to display one or more descriptions responsive to detection of the association. For example, the data circuit 125 may cause a user interface to display descriptions of one or more shampoos based on the association between interactions and a product type. As another example, the data circuit 125 may cause a user interface to display descriptions of one or more pill containers based on associations between interactions and medication storage.

In some embodiments, the prompt circuit 130 may provide and/or input one or more prompts to the ML model 122. For example, the prompt circuit 130 may provide prompts to modify and/or adjust the ML model 122. As another example, the prompt circuit 130 may provide prompts to the ML model 122 to cause the ML model 122 to perform one or more given operations.

In some embodiments, the prompt circuit 130 may input one or more prompts to indicate a context of the descriptions. For example, the prompt circuit 130 may input a prompt to the ML model 122 to indicate that descriptions include reference to a given holiday (e.g., a context). As another example, the prompt circuit 130 may input a prompt to indicate that descriptions include reference to a sporting event. In some embodiments, the description generator 135 may cause the ML model 122 to generate one or more descriptions based on the prompts provided by the prompt circuit 130.

In some embodiments, the prompt circuit 130 may provide a prompt, to the ML model 122, to indicate a display format of the descriptions. For example, the prompt circuit 130 may provide a prompt to indicate that the descriptions may be displayed in a mobile version of a website. As another example, the prompt circuit 130 may provide a prompt to indicate that the descriptions may be displayed in a mobile application. As another example, the prompt circuit 130 may provide a prompt to indicate that the descriptions may be displayed on a non-mobile version of a website.

In some embodiments, the evaluation circuit 140 may analyze a format of the descriptions generated by the ML model 122. For example, the evaluation circuit 140 may analyze the descriptions to determine that the descriptions are in a format associated with prompts provided by the prompt circuit 130. As another example, the evaluation circuit 140 may determine that the descriptions do not conform to a display format as indicated by the prompts provided by the prompt circuit 130. Stated otherwise display format may indicate or otherwise identify rules dictate or specify an arrangement or structure for descriptions.

In some embodiments, the data circuit 125 may transmit signals to cause a display device to display the descriptions responsive to the descriptions conforming to the display formats. For example, the data circuit 125 may transmit one or more signals to cause the user device 165 to display a given description in a mobile version of a website based on the description conforming to a display format for the mobile version. As another example, the data circuit 125 may transmit one or more signals to cause a given description to be displayed within a mobile application.

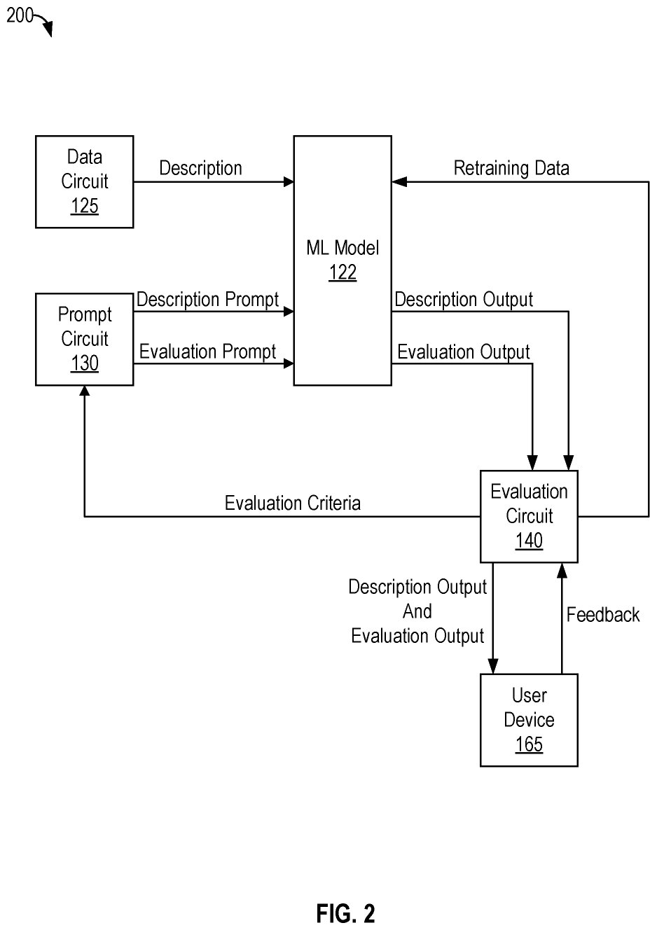

FIG. 2 depicts a workflow 200, according to some embodiments. In some embodiments, the workflow 200 may represent and/or illustrate one or more steps, actions, processes, and/or transmissions to implement, evaluate, control, retrain, and/or otherwise utilize the ML model 122. For example, the workflow 200 may represent steps to cause the ML model 122 to generate one or more descriptions. As another example, the workflow 200 may represent steps to retrain the ML model 122. While the workflow 200 is shown to include given systems, devices, and/or components of the system 100, this for illustrative purposes only and is in no way limiting.

As shown in FIG. 2., the data circuit 125 may provide and/or input one or more descriptions into the ML model 122. In some embodiments, the descriptions may include the various descriptions described herein. For example, the descriptions may include the descriptions 160. The data circuit 125 may input the descriptions into the ML model 122 to cause the ML model 122 to generate one or more second descriptions.

As shown in FIG. 2, the prompt circuit 130 may provide and/or input one or more description prompts into the ML model 122. The description prompts may refer to and/or include prompts to modify the ML model 122 to generate one or more descriptions based on a given criteria. For example, the description prompts may indicate a given display format for the ML model 122 to generate the descriptions in. As another example, the description prompts may modify and/or adjust one or weights and/or nodes of the ML model 122.

As shown in FIG. 2, the ML model 122 may provide one or more description outputs to the evaluation circuit 140. In some embodiments, the description outputs may include one or more descriptions generated by the ML model 122. For example, the description outputs may include the second descriptions 160. In some embodiments, the description outputs may include descriptions of one or more products.

As shown in FIG. 2, the evaluation circuit 140 may provide evaluation criteria to the prompt circuit 130. In some embodiments, the evaluation criteria may refer to and/or include information to evaluate a performance of the ML model 122 in generating the descriptions (e.g., the description outputs) of the products. For example, the evaluation criteria may include criteria to evaluate a format of the descriptions. As another example, the evaluation criteria may include criteria to evaluate if the descriptions include a given number of words, sentences, paragraphs, display space, etc. As another example, the evaluation criteria may identify given evaluation metrics to generate to determine a score for the descriptions generated by the ML model 122. The evaluation criteria may indicate that the ML model 122 generate a reference-free BERT score.

As shown in FIG. 2, the prompt circuit 130 may provide one or more evaluation prompts to the ML model 122. In some embodiments, the prompt circuit 130 may generate the evaluation prompts based on the evaluation criteria provided by the evaluation circuit 140. For example, the evaluation prompts may include criteria to evaluate the format of the descriptions generated by the ML model 122. As another example, the evaluation prompts may indicate given evaluation metrics for the ML model 122 to generate for the description outputs. In some embodiments, the prompt circuit 130 may input the evaluation prompts, into the ML model 122, to modify the ML model 122. For example, the prompt circuit 130 may input the evaluation prompts, into the ML model 122, to cause the ML model 122 to perform one or more evaluation steps. As another example, the prompt circuit 130 may input the evaluation prompts to cause the ML model 122 to generate a BERT score for the description outputs.

As shown in FIG. 2, the ML model 122 may provide one or more evaluation outputs to the evaluation circuit 140. In some embodiments, the ML model 122 may provide the evaluation outputs to indicate a performance of the ML model 122 in generating the descriptions. For example, the evaluation outputs may identify one or more descriptions that conform to and/or do not conform to a given format. In some embodiments, the ML model 122 may generate one or more scores. For example, the evaluation outputs may include at least one score and/or evaluation metric, such as the evaluation metrics described herein. be predictions that indicate one or more scores. To continue this example, the scores may indicate a performance of the ML model 122 in generating the descriptions of the products. Stated otherwise, the scores may indicate which descriptions fall above and/or below a percentile. In some embodiments, the scores that fall below the threshold may identify given descriptions, generated by the ML model 122, to provide to the user device 165 for human review and/or human evaluation.

As shown in FIG. 2, the evaluation circuit 140 may provide the description output and the evaluation output to the user device 165. For example, the evaluation circuit 140 may transmit signals to cause the user device 165 to display a user interface that includes the description output and the evaluation outputs. In some embodiments, the evaluation circuit 140 may provide and/or identify which descriptions have scores (e.g., reference metrics, etc.) that fell below a given percentile. Additionally, the evaluation circuit 140 may flag and/or otherwise indicate descriptions for human review and/or human analysis.

In some embodiments, descriptions, generated by the ML model 122, that have a score above the given percentile may be published and/or otherwise provided. For example, the descriptions may be published to one or more online resources (e.g., websites, blogs, social media platforms, etc.). Stated otherwise, the evaluation circuit 140 may approve (e.g., omit from human review) one or more descriptions that have scores above the percentile and may further forward one or more second descriptions that have scores below the percentile for human review. In some embodiments, the human review and/or the human evaluation may include providing feedback regarding the descriptions. For example, the human review may indicate what was wrong and/or lacking from the descriptions. In some embodiments, the human review and/or the human evaluation may include approving (in which case the description is approved for publication) or rejecting (in which case the description might be disapproved and a new description may be generated, or the description may be manually edited upon which the description may then be published).

In some embodiments, the evaluation circuit 140 may provide one or more description outputs associated with evaluation outputs below a given value. For example, the evaluation circuit 140 may provide descriptions outputs that were indicated as not conforming to a given format. In some embodiments, the evaluation circuit 140 may receive feedback from the user device 165. For example, the feedback may indicate errors and/or inaccuracies in the description outputs. As another example, the feedback may identify given description outputs that do not conform to a given display format. As another example, the feedback may identify given description outputs that include word counts below and/or above a given value and/or threshold.

As shown in FIG. 2, the evaluation circuit 140 may retrain the ML model 122 using retraining data. In some embodiments, the evaluation circuit 140 may generate the retraining data based on at least one of the evaluation outputs and/or the feedback. For example, the evaluation circuit 140 may generate retraining data to cause the ML model 122 to generate descriptions with a word count above a threshold given an indication of the threshold in the feedback. In some embodiments, the evaluation circuit 140 may implement reinforcement learning techniques to retrain and/or finetune the ML model 122 based on the scores generated for the descriptions. For example, the evaluation circuit 140 may impose penalties on the ML model 122 for each description that has a score below a given threshold.

In some embodiments, the evaluation circuit 140 may create a data set with data pairs including the originally generated output descriptions and modified output descriptions manually generated by the user, and/or the feedback by the user on the originally generated descriptions. The evaluation circuit 140 may use the data set to retain and/or reinforce the ML model 122. In some embodiments, the evaluation circuit 140 may additionally or alternatively receive data indicating user engagement with the output descriptions generated by the ML model 122 (e.g., data indicating whether, or a rate at which, user engagement with the description results in clicks, conversions such as purchases, or other interactions, abandonments such as a lack of further interactions or conversions, etc.) and utilize the user engagement data to retain the ML model 122 (e.g., such as to reinforce or increase model behavior resulting in descriptions that receive higher levels of engagement and decrease or modify model behavior resulting in descriptions that receive lower levels of engagement).

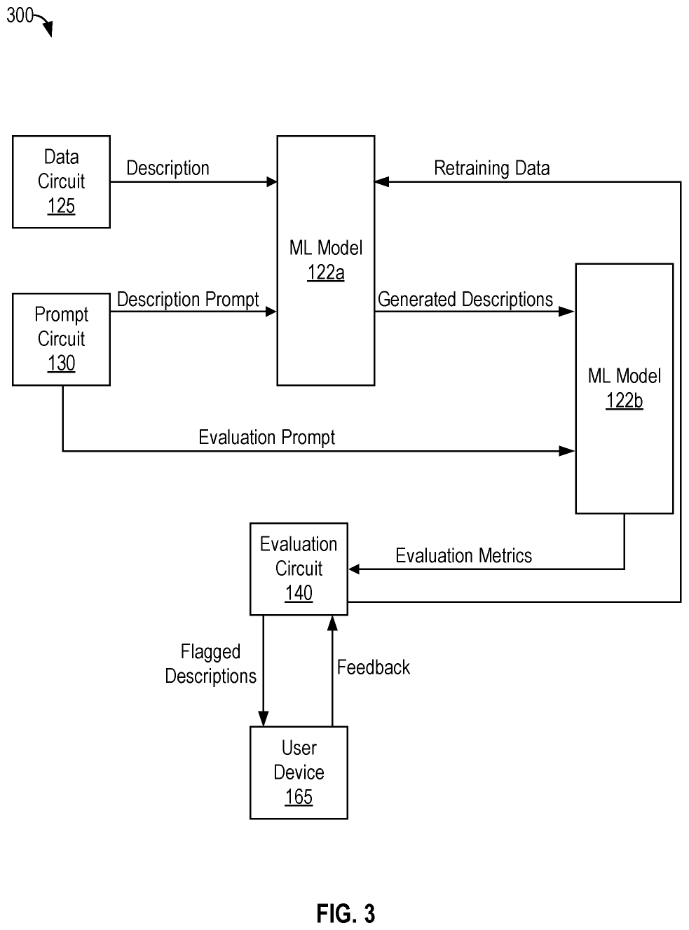

FIG. 3 depicts a workflow 300, according to some embodiments. In some embodiments, the workflow 300 may represent and/or illustrate one or more steps, actions, processes, and/or transmissions to implement, evaluate, control, retrain, and/or otherwise utilize the ML model 122. For example, the workflow 300 may represent steps to cause the ML model 122 to generate one or more descriptions. In some embodiments, the workflow 300 represents steps for causing the ML model 122 and/or a different ML model to evaluate the generated descriptions and determine whether to approve the descriptions (e.g., for final output/publishing), reject the descriptions, and/or identify the descriptions for manual review by a user. As another example, the workflow 300 may represent steps to retrain the ML model 122. In some embodiments, the workflow 300 may replicate, reproduce, and/or include one or more steps, actions, processes, and/or transmissions similar to that of the workflow 200. While the workflow 300 is shown to include given systems, devices, and/or components of the system 100, this for illustrative purposes only and is in no way limiting.

As shown in FIG. 3, the prompt circuit 130 may provide one or more description prompts to a first machine learning model (e.g., a ML model 122a). In some embodiments, the description prompts may include the various prompts described herein. For example, the description prompts may include information to modify the ML model 122a.

As shown in FIG. 3, the ML model 122a may provide one or more generated descriptions to a second Machine Learning model (e.g., a ML model 122b). In some embodiments, the generated descriptions may include descriptions generated by the ML model 122a. For example, the generated descriptions may include second descriptions 160. In some embodiments, the ML model 122a may provide the descriptions, provided by the data circuit 125, to the ML model 122b.

As shown in FIG. 3, the prompt circuit 130 may provide one or more evaluation prompts to the ML model 122b. For example, the prompt circuit 130 may provide evaluation prompts to modify the ML model 122b to cause the ML model 122b to generate one or more evaluation metrics to score the generated descriptions. As another example, the prompt circuit 130 may provide the evaluation prompts to indicate criteria for the ML model 122b to evaluate a performance of the ML model 122a. In some embodiments, the evaluation prompts, the descriptions provided to the ML model 122a, and the generated descriptions may be provided to the ML model 122b. The ML model 122b may generate one or more evaluation metrics and/or scores based on the inputs provided to the ML model 122b. For example, the ML model 122b may generate a BERT score based on a comparison between a first description and a first generated description.

As shown in FIG. 3, the ML model 122b may provide one or more evaluation metrics to the evaluation circuit 140. In some embodiments, the evaluation metrics may include generated scores. For example, the evaluation metrics may include a BERT score generated by the ML model 122b. In some embodiments, the ML model 122b may generate the evaluation based on the evaluation prompt.

In some embodiments, the implementation of the ML model 122a and the ML model 122b, as shown in FIG. 3, illustrates an example of having a first model (e.g., the ML model 122a) generate a description responsive to a prompt (e.g., the description prompt) and based on a second description that is provided to the first model and having a second model (e.g., the ML model 122b) generate a score (e.g., evaluation metric) to indicate how representative the generated description is of the inputted description. In some embodiments, the ML model 122a and the ML model 122b may be the same and/or different models. For example, the ML model 122a and the ML model 122b can be separate models. As another example, the ML model 122a may represent a model that receives a first type of prompt and the ML model 122b may represent the same model but after having received a second prompt.

As another example, the ML model 122b may include multiple models such that a first ML model 122a generates a first score and a second ML model 122b generates a second score. In this example, the evaluation circuit 140 may aggregate and/or otherwise combine the first score and the second score to generate a total score. The first ML model 122a and the second ML model 122b may generate different scores based on receipt of different prompts. For example, the first ML model 122a may receive a first prompt and the second ML model 122b may receive a second prompt.

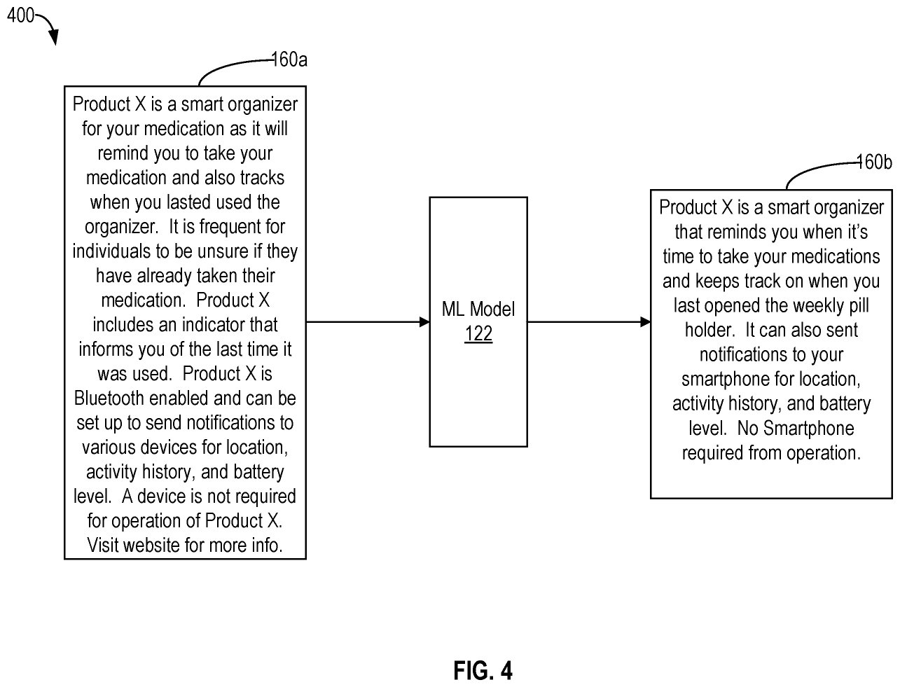

FIG. 4 depicts an illustration 400, according to some embodiments. In some embodiments, the illustration 400 may include at least one first description 160a and/or at least one second description 160b. The first descriptions 160a may refer to and/or include descriptions provided to and/or input into the ML model 122. For example, the description generator 135 may input the first descriptions 160a into the ML model 122. The second descriptions 160b may refer to and/or include descriptions generated by the ML model 122. For example, the ML model 122 may generate the second descriptions 160b based on one or more inputs to the ML model 122. As shown in FIG. 4, the second descriptions 160b may include and/or reference information included in the first descriptions 160a. For example, the second descriptions 160b may include a product name as indicated by the first description 160a.

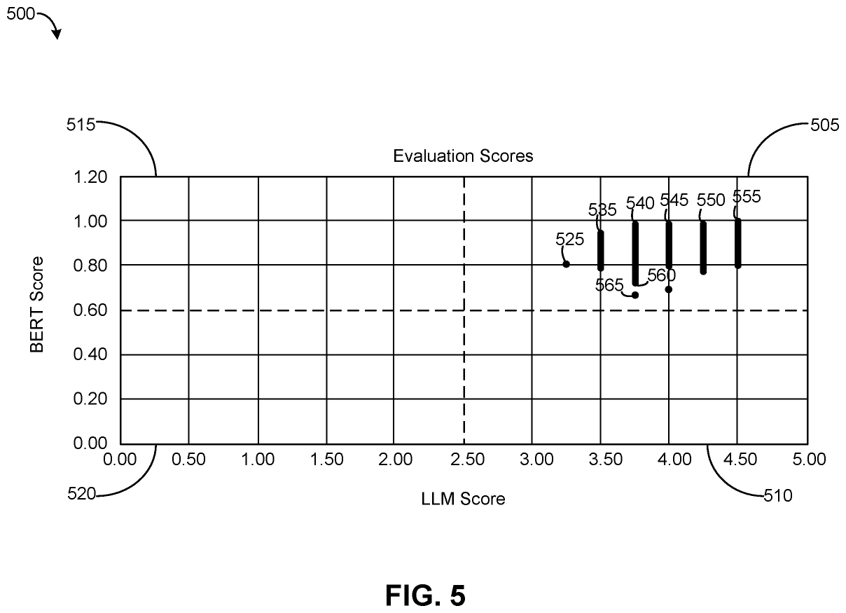

FIG. 5 depicts a graph 500, according to some embodiments. In some embodiments, the graph 500 may refer to and/or include scores to indicate a performance of the ML model 122. For example, the graph 500 may include scores associated with one or more descriptions generated by the ML model 122. In some embodiments, at least one system, device, and/or component of the system 100 may generate the scores of the graph 500. For example, the evaluation circuit 140 may generate the scores. As another example, the ML model 122 may generate the scores.

In some embodiments, the evaluation circuit 140 may generate the scores based on one or more metrics and/or calculations, such as by using one or more machine learning models. For example, the evaluation circuit 140 may generate one or more Bidirectional Encoder Representations from Transformers (BERT) scores for the descriptions 160 generated by the ML model 122. The BERT scores may include reference free BERT scores. For example, the BERT scores may be generated without comparison to user defined descriptions. In some embodiments, the evaluation circuit 140 may implement and/or user a pre-trained BERT language model (e.g., the ML model 122, the first ML model 122a, the second ML model 122b, etc.) to compute similarities between the descriptions provided to the ML model 122 and the descriptions generated by the ML model 122. In some embodiments, the BERT scores may be generated by comparing user provided descriptions to descriptions generated by the ML model 122.

In some embodiments, pre-trained BERT language models may be able to understand semantic similarities and as such may be able to compute similarities and/or differences between the descriptions. For example, the pre-trained BERT language model may produce given BERT scores between referenced descriptions (e.g., user provided descriptions) and descriptions generated by the ML model 122. However, evaluation of descriptions with user provided descriptions may cause delays as the user provided descriptions are needed to compute the scores. As another example, the pre-trained BERT language model may product given BERT scores between retrieved descriptions and descriptions generated by the ML model 122.

As another example, the evaluation circuit 140 may additionally or alternatively generate one or more scores based on an LLM-based model, such as by using the ML model 122 and/or a different LLM-based model. In some implementations, the evaluation circuit may use an evaluation framework such as G-Eval. For example, the evaluation circuit 140 may implement a chain-of-thought (Cot) and/or form-filing paradigm to utilize a Machine Learning model to generate a G-Eval score that is indicative of how well the generated description is representative of a description that input into the model. While some examples described herein have reference certain scores that may be generated to evaluate a performance in generating descriptions for products, these examples are for illustrative purposes only and in way are limiting.

In some embodiments, the evaluation circuit 140 may combine and/or otherwise aggregate one or more scores to determine one or more percentiles. For example, the evaluation circuit 140 may aggregate one or more BERT scores with one or more G-Eval scores to compute an overall score for descriptions generated by the ML model 122. In some embodiments, the evaluation circuit 140 may forward and/or provide given descriptions based on the overall score for the descriptions. For example, the evaluation circuit 140 may forward, to the user device 165, one or more descriptions that have an overall score below a given threshold. As another example, the evaluation circuit 140 may forward, to the user device 165, one or more descriptions that have sub-score (e.g., a BERT score, a G-eval score, etc.) below a given threshold. In some embodiments, the evaluation circuit 140 may receive, from the user device 165, one or more modification and/or adjustments to the descriptions. For example, the evaluation circuit 140 may receive indications of changes that a user made to descriptions that had scores below a predetermined threshold.

As shown in FIG. 5, the graph 500 includes quadrants 505, 510, 515, and 520. The quadrants may define and/or represent regions for which one or more evaluation metrics may be represented. For example, as shown in in FIG. 5, the quadrant 505 is shown to include BERT scores that are greater than 0.60 and an LLM score (e.g., a G-eval score, chain of thought, LLM eval score, etc.). As shown in FIG. 5, the quadrant 505 includes scores 525, 535, 540, 545, 550, 55, 560, and 565. In some embodiments, the scores may represent one or more evaluation metrics generated by the ML model 122. For example, the score 525 may indicate a given BERT score and a given LLM score that was generated for a given generated description. In some embodiments, the placement and/or location of the scores, within the graph and/or one or more quadrants, may establish or define one or more percentiles. For example, the score 525 may fall within the lowest percentile of the graph as the score 525 has the lowest LLM score. As another example, the score 565 may fall within the lowest percentile given that the score 540 and the score 565 have similar LLM scores but the score 565 has a lower BERT score.

In some embodiments, the ML model 122 may take and/or perform one or more actions based on which quadrant a given score falls in. For example, the ML model 122 may automatically forward any generated description, for manual review and/or manual evaluation, based on the score being located in the quadrant 520. As another example, the ML model 122 may approve and/or publish any generated description that has a score that falls in the quadrant 505. In some embodiments, a first ML model (e.g., the ML model 122a) may generate the BERT scores and a second ML model (e.g., the ML model 122b) may generate the LLMs scores. In other embodiments, a first model may generate the BERT scores based on a first prompt and the first model may generate the LLM scores based on a second prompt.

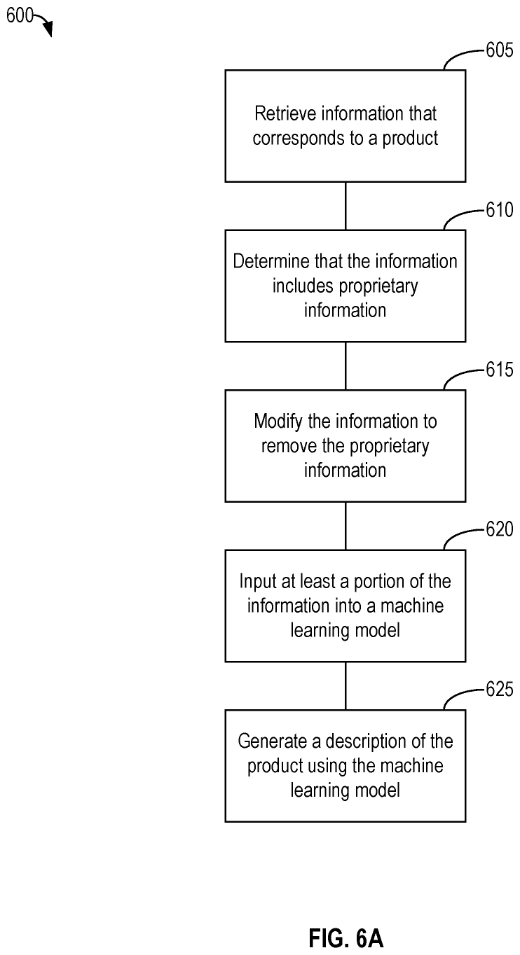

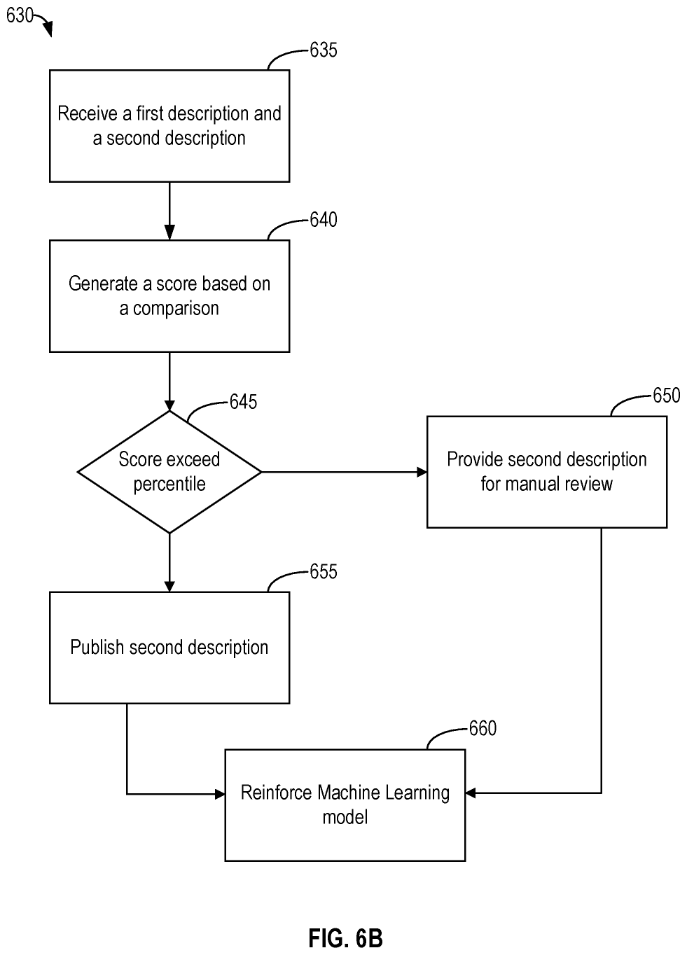

FIG. 6A depicts a flow diagram of a method 600 to generate descriptions of one or more products, according to some embodiments. In some embodiments, the method 600 may be performed responsive to implementation of the ML model 122. For example, the method 600 may be implemented responsive to retraining the ML model 122 as described with respect to the workflow 200 and/or the workflow 300. In some embodiments, at least one step of the method 600 may be performed by at least one of the various systems, devices, and/or components described herein. For example, the product system 105 may perform at least one step of the method 600. In some embodiments, at least one step of the method 600 may be repeated, reproduced, reimplemented, and/or otherwise duplicated. In some embodiments, memory 120 may store instructions that, when executed by the processors 115, cause the processors 115 to perform at least one step of the method 600.

In some embodiments, at step 605, information that corresponds to a product may be retrieved. For example, the data circuit 125 may retrieve the descriptions 160 from the database 155. In some embodiments, the data circuit 125 may retrieve one or more descriptions 160 to use as training data for the ML model 122. For example, the one or more descriptions 160 may be used during supervised and/or unsupervised training of the ML model 122. In some embodiments, the descriptions 160 may correspond to and/or be associated with one or more products. For example, a first given description 160 may correspond to and/or describe a first product. As another example, a second given description 160 may correspond to and/or describe a second product.

In some embodiments, at step 610, it may be determined that the information includes proprietary information. For example, the data circuit 125 may determine that one or more descriptions, of the descriptions retrieved in step 605, include information, such as trademarks, copyrights, slogans, catchphrases, etc. In some embodiments, the data circuit 125 may determine that the descriptions 160 include proprietary information responsive to an evaluation of the descriptions 160. For example, the data circuit 125 may check for matches between portions of the descriptions 160 and a list of proprietary information. In this example, the data circuit 125 may determine that the descriptions 160 include proprietary information based on one or more matches between the descriptions 160 and the list of proprietary information.

In some embodiments, at step 615, the information may be modified to remove the proprietary information. For example, the data circuit 125 may perform data cleansing and/or data scrubbing to remove the proprietary information from the descriptions 160. In some embodiments, the data circuit 125 may remove the proprietary information to prevent subsequent generation of descriptions based on information, such as slogans, catchphrases, etc.

In some embodiments, at step 620, at least a portion of the information may be input into a Machine Learning (ML) model. For example, the description generator 135 may provide, as one or more inputs, the information that was modified in step 615 to the ML model 122. As another example, the data circuit 125 may provide the information as one or more parameters for which the ML model 122 may use to generate descriptions.

In some embodiments, at step 625, a description of a product may be generated using the ML model. For example, the description generator 135 may utilize and/or implement the ML model 122 to generate one or more descriptions based on the information inputted into the model in step 620. As another example, the ML model 122 may receive one or more first descriptions 160. To continue this example, the ML model 122 may generate, based on the one or more first descriptions 160, one or more second descriptions 160 to describe one or more products.

FIG. 6B depicts a flow chart of a method 630 to evaluate descriptions generated by one or more models, according to some embodiments. In some embodiments, the method 630 may be performed responsive to generation of the descriptions 160 by the ML model 122. For example, the method 630 may be implemented responsive to ML model 122a outputting the generated descriptions as described with reference to the workflow 300. In some embodiments, at least one step of the method 630 may be performed by at least one of the various systems, devices, and/or components described herein. For example, the product system 105 may perform at least one step of the method 630. In some embodiments, at least one step of the method 630 may be repeated, reproduced, reimplemented, and/or otherwise duplicated. In some embodiments, memory 120 may store instructions that, when executed by the processors 115, cause the processors 115 to perform at least one step of the method 630.

In some embodiments, at step 635, a first description and a second description may be received. For example, the evaluation circuit 140 may receive the first description and the second description. In some embodiments, the first description may refer to and/or include a description provided to and/or otherwise inputted in a model (e.g., the ML model 122) and the second description may refer to and/or include a description generated by the model based on the first description.

In some embodiments, at step 640, a score based on a comparison may be generated. For example, the ML model 122b may generate an evaluation metric (e.g., a score) based on a comparison between the first description and the second description. As another example, the ML model 122b may generate the scores illustrated in FIG. 5. In some embodiments, the score may include one or more scores. For example, the score may include a BERT score and an LLM score. As another example, the score may include a first score generated by a first model and a second score generated by a second model.

In some embodiments, at step 645, a determination as to whether the score exceeds a percentile may be made. For example, the evaluation circuit 140 may determine a given quadrant of the graph 500 that the score, generated in step 640, is located in. As another example, the evaluation circuit 140 may determine if the score is above and/or below a given threshold (e.g., percentile). In some embodiments, the method 630 may proceed to step 650 responsive to a determination that the score is below the percentile. In some embodiments, the method 630 may proceed to step 655 responsive to a determination that the score exceeds the percentile.

In some embodiments, the evaluation circuit 140 may evaluate the score to determine whether a generated description (e.g., the second description) is ready for publication. For example, the evaluation circuit 140 may serve as a filter to prevent publication of descriptions that fall below a given threshold while allowing descriptions that fall above the threshold to be published (e.g., approved). When descriptions fall below the threshold, the evaluation circuit 140 may prompt a user for manual review and/or manual evaluation of the descriptions to provide feedback regarding rather the model should be retrained and/or finetuned.

In some embodiments, at step 650, the second description may be provided for manual review. For example, the evaluation circuit 140 may provide the second description, received in step 635, to the user device 165 for manual review by a user of the user device 165. In some embodiments, the evaluation circuit 140 may provide the second description responsive to a determination that the second description does not include one or more characteristics. For example, the evaluation circuit 140 may determine that the second description does not include enough information (e.g., short, brief, non-descriptive, etc.). As another example, the evaluation circuit 140 may determine that the format of the second description does not conform to a predetermined format.

In some embodiments, at step 655, the second description may be published. For example, the evaluation circuit 140 may approve the second description for distribution by one or more resources. As another example, the evaluation circuit 140 may approve the second description for display or presentation by one or more online sources (e.g., websites, blogs, social media platforms, etc.).

In some embodiments, at step 660, a machine learning model may be reinforced. For example, the evaluation circuit 140 may reinforce the ML model 122 responsive to feedback and/or input provided during the manual review of the second description. As another example, the evaluation circuit 140 may reinforce the ML model 122 responsive to the second description being published. In some embodiments, the evaluation circuit 140 may reinforce the ML model 122, responsive to the second description undergoing manual review, by imposing one or more penalties on the ML model 122. In other embodiments, the evaluation circuit 140 may reinforce the ML model 122 by providing the second description as subsequent training data for the ML model 122.

### Product Substitutions

In some embodiments, the product system 105 may generate one or more user interfaces that include the descriptions 160. For example, the product system 105 may generate a user interface that includes a graphical representation (e.g., an image, a picture, a rendering, etc.) of descriptions for one or more products. The user interface may also include a text block that includes given descriptions that correspond to the one or more products. In some embodiments, the product system 105 may display the user interfaces to provide access to the one or more products. For example, a given product may be selected via one or more interactions with the user interface. As another example, a given product may be obtained or reserved based on a selection of the given product within the user interface.

In some embodiments, the selections of given products may include indications of criteria with respect to providing or obtaining a selected product. For example, a first selection may indicate criteria to obtain the product from a given location. As another example, a second selection may indicate criteria to obtain the product by a given time. In some embodiments, an availability (e.g., status) of the product may restrict or reduce access to the product. For example, a product being located at a first location may restrict access to the product at a second location. As another example, a first amount of the product may be available at a second location which may restrict an amount of the product that may be obtained from the second location.

In some embodiments, the product system 105 may identify one or more substitutions (e.g., replacements) for a given product based on the status of the given product. For example, the product system 105 may identify a substitution for a product based on a selection of the product indicating a given location that does not include the product. As another example, the product system 105 may identify a substitution for a product based on a selection of the product indicating a given amount of the product that is not available at a given location.

In some embodiments, the product system 105 may utilize one or more descriptions generated by the ML model 122 (e.g., the descriptions 160) to identify substitutions of products. For example, the product system 105 may evaluate a description of a given product to determine a product type, a product category, or a product classification. In some embodiments, the product system 105 may retrieve, from the database 155, one or more descriptions of products that have similar product types, product categories, or product classifications. Stated otherwise, the product may have a first product type and the product system 105 may retrieve one or more descriptions of products that also have the first product type.

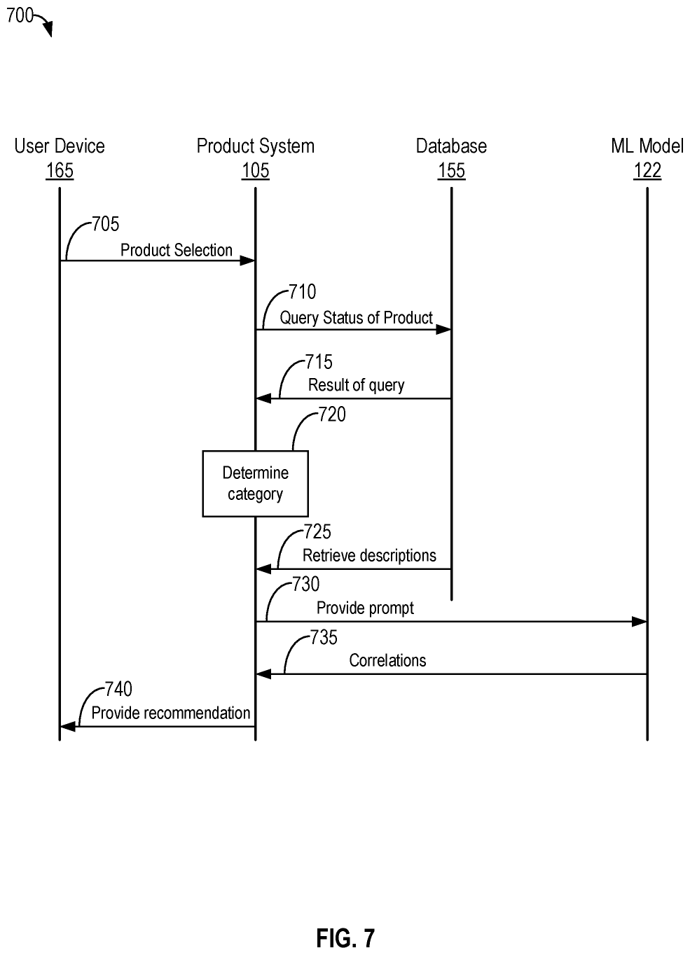

FIG. 7 depicts a sequence diagram of a method 700 to provide recommendations regarding one or more products, according to some embodiments. In some embodiments, the method 700 may be executed or otherwise performed responsive to generation of the descriptions 160 by the ML model 122. While one or more steps of the method 700 may be described herein with respect to a given system, device, and/or component, this is for illustrative purposes only and is no way limiting. In some embodiments, the method 700 may be reproduced, replicated, repeated, and/or otherwise duplicated. While given steps of the method 700 may have been described herein in a given order, this is for illustrative purposed only and is no way limiting.

At step 705, the product system 105 may receive a product selection. For example, the product system 105 may receive a product selection responsive to receipt of one or more signals from the user device 165. As another example, the product system 105 may receive the product selection responsive to one or more interactions with a user interface. In some embodiments, the product selection may include an indication of criteria to obtain the product. For example, the product selection may include an indication of a location to obtain the product from (e.g., a criteria). As another example, the product selection may include an indication of a given amount of the product (e.g., a criteria).

In some embodiments, the product system 105 may receive one or more product selections. For example, the product system 105 may receive a first product selection associated with a first product. As another example, the product system 105 may receive a second product selection associated with a second product. In some embodiments, the selected products (e.g., products indicated in the product selections) may include a given category. For example, a first product may be associated with cold and flu medication (e.g., a first category). As another example, a second product may be associated with hair care (e.g., a second category).

At step 710, the product system 105 may query a status of a product. For example, the product system 105 may transmit one or more API calls to the database 155. As another example, the product system 105 may traverse the database 155. In some embodiments, the product system 105 may query a status of a product indicated in step 705. For example, the product system 105 may query a status of a product indicated by a given product selection. In some embodiments, the product system 105 may query the status of the product by providing an identification of the product. For example, the product system 105 may provide a name of the product to query a status of the product.

At step 715, the product system 105 may receive a result of the query. For example, the product system 105 may receive an indication of the status of the product from the database 155. As another example, the product system 105 may receive information that identifies the status of the product. In some embodiments, the product system 105 may receive information that indicates at least one of a location of the product, an amount of the product available at a given location, and/or an amount of time until the product may be available at a given location.

At step 720, the product system 105 may determine a category of the product. For example, the product system 105 may extract the category of the product from the product selection. As another example, the product system 105 may scrap the category of the product from a data source associated with the product. In some embodiments, the product system 105 may determine the category of the product based on a description associated with the product. For example, the product system 105 may retrieve, from the database 155, a description of the product generated by the ML model 122 and the description may indicate the category of the product. In some embodiments, the product system 105 may extract the category of the product from the description.

At step 725, the product system 105 may retrieve descriptions. For example, the product system 105 may retrieve, from the database 155, descriptions associated with one or more products that have the category determined in step 720. Stated otherwise, the product selection may be a product having a first category as determined in step 720. As such, the product system 105 may retrieve one or more descriptions from the database 155 that are indicated as having the first category. As another example, the product system 105 may transmit one or more API calls to prompt the database 155 to provide one or more descriptions tagged as corresponding to products having the first category.

In some embodiments, the product system 105 may retrieve descriptions based on the status of products. For example, the product system 105 may retrieve descriptions for given products based on locations of the given products. As another example, the product system 105 may retrieve descriptions for given products based on an amount of the given products at a given location. Stated otherwise, the product system 105 may restrict retrieval of descriptions such that the product system 105 only retrieves products that are available.

At step 730, the product system 105 may provide one or more prompts. For example, the product system 105 may provide a prompt to the ML model 122. In some embodiments, the product system may provide prompts to cause the ML model 122 to perform one or more actions. For example, the product system 105 may provide a prompt to the ML model 122 to cause the ML model 122 to generate predictions of correlations. In some embodiments, the correlations may between a description of a given product and the descriptions retrieved in step 725. For example, the ML model 122 may generate outputs that indicate a correlation between the selected product and one or more products associated with the descriptions retrieved in step 725.

As a non-limiting example, the product selection may indicate a product (e.g., a selected product) associated with hair care (e.g., a category). In this example, the product may be a shampoo. To continue this example, the product selection may indicate a given size of the product. In this example, the product system 105 may query the database 155 to determine a status of the product. To continue this example, the product system 105 may determine, based on the results of the query, that the given size of the product is not available at a location indicated in the product selection. In this example, the product system 105 may determine that the product is associated with hair care. To continue this example, the product system 105 may retrieve descriptions (e.g., retrieved descriptions) associated with products that also pertain to hair care. In this example, the product system 105 may provide a description of the selected product and the retrieve descriptions to the ML model 122. To continue this example, the product system 105 may provide a prompt, to the ML model 122, that provides an indication for the ML model 122 to generate predictions of correlations between the descriptions.

At step 735, the product system 105 may receive one or more correlations. For example, the product system 105 may receive correlations as one or more outputs of the ML model 122. In some embodiments, the correlations may indicate relationships between products. For example, a given output of the ML model 122 may provide a correlation between a selected product and a product associated with a given description retrieved in step 725. In some embodiments, the ML model 122 may generate the correlations based on comparisons between the descriptions. For example, the ML model 122 may extract phrases and words from a first description and a second description. The ML model 122 may compare the extract phrases and words to detect similarities. For example, the ML model 122 may detect that a first description and a second description are correlated based on similarities between phrases included in the first description and the second description.

In some embodiments, the ML model 122 may generate the correlations based on semantic similarities between descriptions. For example, the ML model 122 may perform natural language processing on a first description and a second description. The ML model 122 may detect correlations based on the natural language processing. For example, the ML model 122 may detect that one or more portions of a first description are similar to one or more portions of a second description.

At step 740, the product system 105 may provide a recommendation. For example, the product system 105 may provide a recommendation of one or more products to replace the product indicated in the product selection in step 705. In some embodiments, the product system 105 may provide the recommendation by display information to indicate the one or more products via a user interface. For example, the product system 105 may transmit one or more signals to the user device 165 to cause the user device 165 to display and/or update a user interface to include a graphical representation of the recommendation.

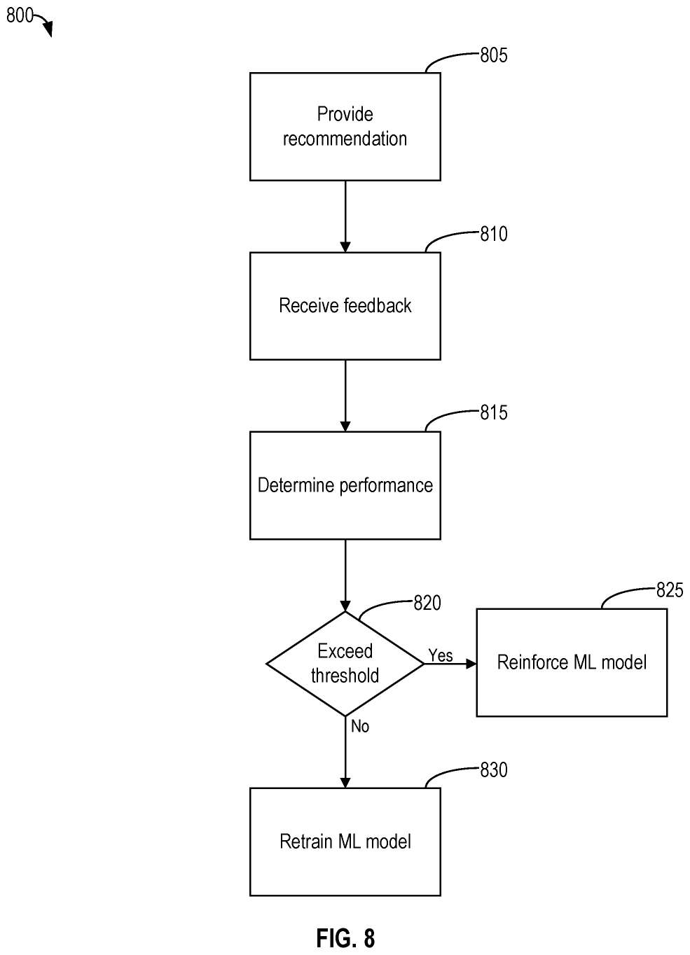

FIG. 8 depicts a flow chart of a method 800 to evaluate outputs generated by a machine learning (ML) model, according to some embodiments. In some embodiments, at least one of the various systems, devices, and/or components described herein may perform and/or otherwise implement at least step of the method 800. For example, the product system 105 may perform at least one step. In some embodiments, the method 800 and/or one or more steps thereof may be repeated, reproduced, replicated, and/or otherwise duplicated.

At step 805, at least one recommendation may be provided. For example, the product system 105 may provide a recommendation to the user device 165. In some embodiments, the product system 105 may provide the recommendation by causing a user interface to be display and/or updated. For example, the product system 105 may transmit one or more signals that cause the user device 165 to display a user interface that includes the recommendation. In some embodiments, the step 895 may refer to and/or include the step 740.

At step 810, feedback may be received. For example, the product system 105 may receive feedback regarding the recommendation provided in step 805. In some embodiments, the product system 105 may receive the feedback responsive to one or more interactions with a user interface. For example, a user interface that includes the recommendation may also include one or more elements (icons, checkboxes, etc.). In some embodiments, a given element may correspond to a given recommended product (e.g., a product to replace a product indicated in a product selection).

In some embodiments, the product system 105 may receive feedback for a given recommended product based on a selection of a given element. For example, the user interface may include a first element that may be selected to provide feedback to indicate that the selected product and the recommended product are similar. As another example, the user interface may include a second element that may be selected to provide feedback that indicates that the products are not similar.

At step 815, a performance may be determined. For example, the product system 105 may determine a performance of the ML model 122 in generating correlations between products based on the feedback received in step 810. For example, the product system 105 may determine a percentage of recommended products that were indicated as being similar to a selected product. Stated otherwise, the product system 105 may determine how many recommended products, relative to a total number of recommended products, were indicated as being similar to a selected product.

At step 820, a determination as to whether a threshold is exceeded may be determined. For example, the ML model 122 may have a performance threshold (e.g., percentage of recommended products indicated as being similar to selected products). In some embodiments, the product system 105 may compare the performance, determined in step 815, with the performance threshold. For example, the performance threshold may be a given percentage and the product system 105 may determine if a percentage, determined in step 810, exceeds the given percentage. In some embodiments, the method 800 may proceed to step 825 responsive to a determination that the performance of the ML model 122 exceeds the threshold. In some embodiments, the method 800 may proceed to step 830 responsive to a determination that the performance of the ML model 122 does not exceed the threshold.

At step 825, the ML model 122 may be reinforced. For example, the product system 105 may validate or otherwise confirm that current parameters and/or weights for the ML model 122 may be maintained. As another example, the product system 105 may prevent subsequent adjustment of parameters and/or weights used by the ML model 122 to generate correlations.

At step 830, the ML model 122 may be retrained. For example, the product system 105 may retrain the ML model 122 based on the feedback received in step 810. In some embodiments, the product system 105 may receive feedback that includes an indication of a product that was absent from the recommendation but nonetheless was still related to the selected product. The product system 105 may adjust one or more parameters and/or weights of the ML model 122 to reflect the indication of the product that was absent from the recommendation.

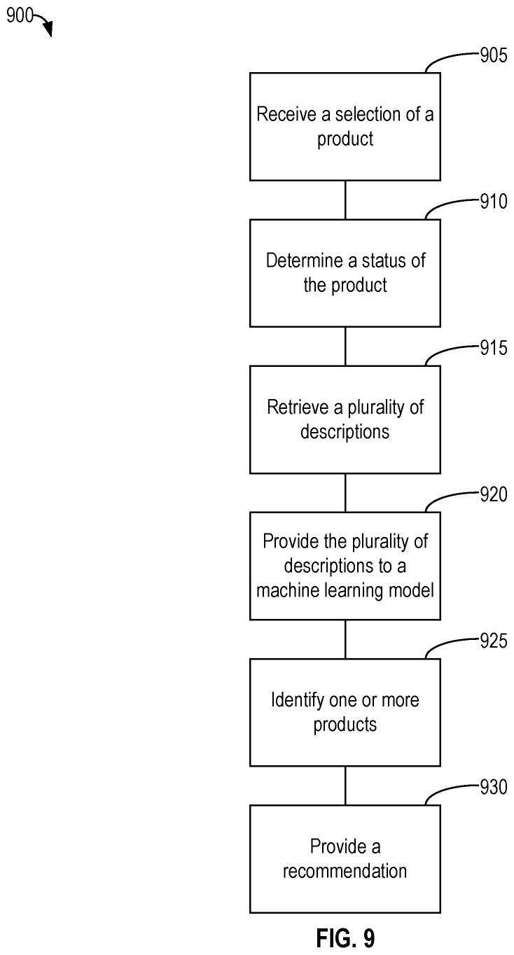

FIG. 9 depicts a flow diagram of a method 900 to provide recommendations regarding one or more products, according to some embodiments. In some embodiments, the method 900 may be performed responsive to implementation of the ML model 122. For example, the method 900 may be implemented responsive to retraining the ML model 122 as described with respect to the workflow 200 and/or the workflow 300. In some embodiments, at least one step of the method 900 may be performed by at least one of the various systems, devices, and/or components described herein. For example, the product system 105 may perform at least one step of the method 900. In some embodiments, at least one step of the method 900 may be repeated, reproduced, reimplemented, and/or otherwise duplicated. In some embodiments, memory 120 may store instructions that, when executed by the processors 115, cause the processors 115 to perform at least one step of the method 900.

At step 905, a selection of a product may be received. For example, the product system 105 may receive one or more signals from the user device 165 that provide indications of one or more interactions with a user interface. In some embodiments, the interactions may include a selection of product. For example, a given interaction may include selecting an element associated with a given product to provide indication of selection of the product. In some embodiments, the product may have a given category. For example, the product may be associated with medication containers (e.g., a category). As another example, the product may be associated with cold and flu medication (e.g., a category)

At step 910, a status of the product may be determined. For example, the product system 105 may query the database 155 to retrieve information associated with the product. In some embodiments, the product system 105 may determine a status of a product based on at least one of one or more locations that include the product, an amount of the product located at the one or more locations, and/or an amount until the product may be available at the one or more locations. For example, the product system 105 may determine a status of a product responsive to determining that the product is located at a first location and a second location.

In some embodiments, the product system 105 may determine that the status of the product does not align with the information included in the selection of the product. For example, the selection of the product may indicate a given amount of the product to obtain from a given location. In this example, the product system 105 may determine that the status (e.g., how much is available at the given location) is less than the given amount of the product indicated in the selection of the product.

At step 915, a plurality of descriptions may be retrieved. For example, the product system 105 may retrieve one or more descriptions from the database 155 based on the category of the selected product. For example, the category of the selected may be cold and flu medication. In this example, the product system 105 retrieve one or more descriptions from the database 155 that are identified as correspond to cold and flu medication. In some embodiments, the product system 105 may retrieve the one or more descriptions responsive based on the status of the selected product. For example, the product system 105 may retrieve the one or more descriptions based on a location of the product (e.g., status) being different than a location indicated in the selection of the product.

At step 920, the plurality of descriptions may be provided to a machine learning (ML) model. For example, the product system 105 may provide the descriptions, retrieved in step 915, as one or more inputs to the ML model 122. In some embodiments, the product system 105 may provide a description of the product selected in step 905. The ML model 122 may generate one or more outputs based on the descriptions provided by the product system 105. In some embodiments, the product system 105 may provide a prompt to the ML model 122 to cause the ML model 122 to generate one or more outputs. For example, the product system 105 may provide a prompt, such as “identify correlations between description 1 and description 2” to cause the ML model 122 to generate outputs. In this example, description 1 may represent the description of the selected product and description 2 may represent the descriptions retrieved in step 915.

In some embodiments, the ML model 122 may implement semantic analysis to identify the correlations between the descriptions. For example, the ML model 122 may perform natural language processing to evaluate the descriptions. In some embodiments, the ML model 122 may identify correlations between the descriptions by detecting patterns and/or similarities between the descriptions. For example, the ML model 122 may detect that a first description and a second description include similar phrases. As another example, the ML model 122 may detect that a first description and a second description list include similar ingredients. In some embodiments, the ML model 122 may generate one or more outputs that indicate and/or include the correlations between the description. In other embodiments, the ML model 122 may output indications of one or more products identified as being correlated to the selected product based on the descriptions of the one or more products and the description of the selected product.

At step 925, one or more products may be identified. For example, the product system 105 may identify one or more products indicated by the ML model 122. As another example, the product system 105 may identify one or more products that correspond to descriptions output by the ML model 122. In some embodiment, the product system 105 may compile and/or otherwise aggregate the products output by the ML model 122. For example, the product system 105 may generate a list that includes the products identified in step 925.

At step 930, a recommendation may be provided. For example, the product system 105 may provide a recommendation of the products identified in step 925. In some embodiments, the product system 105 may provide the recommendation via a user interface. For example, the product system 105 may cause a display device to display and/or update a user interface to include the recommendation. In some embodiments, the recommendation may include an indication of one or more products to replace the product selected in step 905. For example, the recommendation may include an indication of a given product that is similar to the product selected in step 905. In this example, the recommendation may suggest replacing the product selected in step 905 with the given product. In some embodiments, the product system 105 may provide the recommendation to assist in identifying one or more products to replace the product selected in step 905. For example, the product selected in step 905 may not be located in a given location (e.g., a status). The product system 105 may provide the recommendation to indicate one or more products that are similar to the product and that are also located in the given location.

In some embodiments, the recommendation may include one or more elements. For example, the recommendation may include icons, text boxes, dropdowns, menus, and/or graphics. In some embodiments, the product system 105 may display a graphical representation of the recommendation. The graphical representation of the recommendation may include one or more elements to illustrate and/or indicate given pieces of information. For example, the graphical representation of the recommendation may include a first element to provide the description of the product selected in step 905. As another example, the graphical representation of the recommendation may include a second element to provide a description of the one or more products identified in step 920. As another example, the graphical representation of the recommendation may include a third element to select a given product of the one or more products.

In some embodiments, the product system 105 may receive a selection of one or more subsequent products. For example, the product system 105 may receive a selection of a given product included in and/or indicated by the recommendation provided in step 930. As another example, the product system 105 may receive a selection of a given product responsive to interaction with the graphical representation of the recommendation.

In some embodiments, the product system 105 may provide one or more prompts via the user interface. For example, the product system 105 may cause the user interface to display a request to provide a given indication. As another example, the product system 105 may cause the user interface to display a request to provide a given indication. In some embodiments, the product system 105 may provide a prompt to provide the recommendation. Stated otherwise, the product system 105 may provide a request to receive an indication to provide the recommendation. In some embodiments, the product system 105 may retrieve the descriptions in step 915 responsive to receipt of an indication to provide the recommendation.

In some embodiments, the product system 105 may update a status of the subsequent products to reflect selection. For example, the product system 105 may update the database 155 to reduce and/or adjust an amount of the product that may be available at a given location based on the selection of the product. As another example, the product system 105 may update the database 155 to reflect that a product is no longer located at a given location.

In some embodiments, the product system 105 may prevent subsequent retrieval of the subsequent products. For example, the product system 105 may no longer retrieve a description of the subsequent products based on the change in status of the subsequent products (e.g., no longer available, etc.). In some embodiments, the product system 105 may prevent subsequent retrieval of the subsequent products to limit the descriptions provided to the ML model 122 to descriptions associated with products that are available.

In some embodiments, the product system 105 may cause the user interface to include a graphical representation of the product selected in step 905. For example, the product system 105 may cause the user interface to include an image of the product selected in step 905. In some embodiments, the product system 105 may update the user interface to reflect identification of the products in step 925. For example, the product system 105 may update the user interface to replace the graphical representation of the product selected in step 905 with graphical representations of the one or more products identified in step 925.

The arrangement, construction, and description of the systems and methods as shown in the various exemplary embodiments are illustrative only. While some embodiments have be described herein, several modifications and/or adjusts are possible (e.g., variations in sizes, dimensions, structures, shapes and proportions of the various elements, values of parameters, mounting arrangements, use of materials, colors, orientations, etc.). For example, the position of elements can be reversed, modified, adjusted, and/or rearranged. As another example, the nature or number of discrete elements or positions can be altered or varied. Accordingly, all such modifications are intended to be included within the scope of the present disclosure. The order or sequence of any process or method steps described herein can be varied or re-sequenced according to alternative embodiments. Other substitutions, modifications, changes, and omissions can be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system comprising one or more memory devices storing instructions thereon that, when executed by one or more processors, cause the one or more processors to:
retrieve information for a product of an entity, the information comprising a first description of the product;
determine, based on an evaluation of the information, that the information includes proprietary information associated with the product or the entity;
modify the information to remove the proprietary information from the information;
input the modified information into a machine learning model; and
generate, using the machine learning model, a second description of the product using the modified information, the machine learning model configured to generate the second description to conform with one or more characteristics.

2. The system of claim 1, wherein the product corresponds to a first product type, and wherein the instructions cause the one or more processors to:
store, responsive to generation of the second description of the product, the second description of the product in a database that corresponds to the first product type;
detect, based on one or more interactions with a user interface, an association between the one or more interactions and the first product type; and
cause, responsive to detection of the association, the second description of the product to be included in the user interface.

3. The system of claim 1, wherein the machine learning model includes a first machine learning model and a second machine learning model, and wherein the instructions cause the one or more processors to:
provide, to the first machine learning model, a prompt to generate the second description of the product using the first description of the product;
generate, using the first machine learning model, the second description of the product; and
provide, responsive to generation of the second description of the product, the first description of the product and the second description of the product to the second machine learning model to cause the second machine learning model to generate a score to indicate correlations between the first description of the product and the second description of the product.

4. The system of claim 3, wherein the instructions cause the one or more processors to:
determine that the score is below a predetermined threshold;
provide the first description of the product and the second description of the product for manual review to receive one or more adjustments to the second description of the product; and
retrain, responsive to receipt of the one or more adjustments, the machine learning model for subsequent description generation.

5. The system of claim 4, wherein the instructions cause the one or more processors to:
evaluate the one or more adjustments to determine whether to approve the second description of the product; and
approve, responsive to evaluation of the one or more adjustments, the second description of the product.

6. The system of claim 3, wherein the score includes a first score to indicate the correlations between the first description of the product and the second description of the product and a second score to indicate a performance of the machine learning model, and wherein the instructions cause the one or more processors to:
evaluate the first score and the second score to determine whether to provide the second description for manual review; and
determine, responsive to evaluation of the first score and the second score, to provide the second description for manual review.

7. The system of claim 1, wherein a first prompt and the first description of the product are provided to the machine learning model to cause the machine learning model to generate the second description of the product, and wherein the instructions cause the one or more processors to:
provide, responsive to generation of the second description of the product, a second prompt to cause the machine learning model to generate a score to indicate correlations between the first description of the product and the second description of the product.

8. The system of claim 1, wherein the instructions cause the one or more processors to:
provide, to the machine learning model, a prompt to indicate a display format of the second description of the product;
determine, responsive to generation of the second description of the product, that the second description of the product conforms to the display format; and
transmit, to a display device, one or more signals to cause the display device to display the second description of the product in the display format.

9. The system of claim 1, wherein the instructions cause the one or more processors to:
determine, responsive to an evaluation of the second description of the product, that an amount of information included in the second description of the product is below a predetermined threshold;
extract, from an image of the product, a plurality of information that corresponds to the product; and
generate, using the machine learning model, a third description of the product based at least one the plurality of information and the second description of the product.

10. The system of claim 1, wherein the instructions cause the one or more processors to:
provide, to the machine learning model, a prompt to indicate a context of the second description of the product; and
generate, using the machine learning model, the second description of the product based on at least a portion of the modified information and the context of the second description of the product.

11. The system of claim 1, wherein the instructions cause the one or more processors to:
retrieve, from a database, a second plurality of information that corresponds to a plurality of products of the entity, the second plurality of information including a plurality of descriptions of the plurality of products;
input, responsive to retrieval of the second plurality of information, into the machine learning model, at least a portion of the second plurality of information;
generate, using the machine learning model, a second plurality of descriptions of the plurality of products; and
determine, using the machine learning model or a second machine learning model, scores for the second plurality of descriptions to indicate a performance of the machine learning model with respect to generation of the second plurality of descriptions.

12. The system of claim 11, wherein the instructions cause the one or more processors to:
detect, responsive to evaluation of the scores for the second plurality of descriptions, a subset of descriptions of the second plurality of descriptions for which the scores are below a predetermined threshold; and
provide the subset of descriptions for human review.

13. The system of claim 1, wherein the instructions cause the one or more processors to:
transmit, responsive to generation of the second description of the product, one or more signals to cause a display device to display a user interface that provides the second description of the product;
receive, via the user interface, one or more inputs to indicate a performance of the machine learning model with respect to generation of the second description of the product; and
retrain, based at least on the one or more inputs, the machine learning model for subsequent generation of one or more descriptions.

14. A method, comprising:
retrieving, by one or more processing circuits, information for a product of an entity, the information comprising a first description of the product;
determining, by the one or more processing circuits, based on an evaluation of the information, that the information includes proprietary information associated with the product or the entity;
modifying, by the one or more processing circuits, the information to remove the proprietary information from the information;
inputting, by the one or more processing circuits, the modified information into a machine learning model; and
generating, by the one or more processing circuits, using the machine learning model, a second description of the product using the modified information, the machine learning model configured to generate the second description to conform with one or more characteristics.

15. The method of claim 14, wherein the product corresponds to a first product type, further comprising:
storing, by the one or more processing circuits, responsive to generating the second description of the product, the second description of the product in a database that corresponds to the first product type;
detecting, by the one or more processing circuits, based on one or more interactions with a user interface, an association between the one or more interactions and the first product type; and
causing, by the one or more processing circuits, responsive to detecting the association, the second description of the product to be included in the user interface.

16. The method of claim 14, wherein the machine learning model includes a first machine learning model and a second machine learning model, and further comprising:
providing, by the one or more processing circuits, to the first machine learning model, a prompt to generate the second description of the product using the first description of the product;
generating, by the one or more processing circuits, using the first machine learning model, the second description of the product; and
providing, by the one or more processing circuits, responsive to generating the second description of the product, the first description of the product and the second description of the product to the second machine learning model to cause the second machine learning model to generate a score to indicate correlations between the first description of the product and the second description of the product.

17. The method of claim 14, wherein a first prompt and the first description of the product are provided to the machine learning model to cause the machine learning model to generate the second description of the product, and further comprising:
providing, by the one or more processing circuits, responsive to generating the second description of the product, a second prompt to cause the machine learning model to generate a score to indicate correlations between the first description of the product and the second description of the product.

18. The method of claim 14, further comprising:
providing, by the one or more processing circuits, to the machine learning model, a prompt to indicate a display format of the second description of the product;
determining, by the one or more processing circuits, responsive to generating the second description of the product, that the second description of the product conforms to the display format; and
transmitting, by the one or more processing circuits, to a display device, one or more signals to cause the display device to display the second description of the product in the display format.

19. The method of claim 14, further comprising:
determining, by the one or more processing circuits, responsive to an evaluation of the second description of the product, that an amount of information included in the second description of the product is below a predetermined threshold;
extracting, by the one or more processing circuits, from an image of the product, a plurality of information that corresponds to the product; and
generating, by the one or more processing circuits, using the machine learning model, a third description of the product based at least one the plurality of information and the second description of the product.

20. One or more non-transitory computer-readable storage media storing instructions thereon that, when executed by one or more processors, cause the one or more processors to perform operations comprising:
retrieving information for a product of an entity, the information comprising a first description of the product;
determining, based on an evaluation of the information, that the information includes proprietary information associated with the product or the entity;
modifying the information to remove the proprietary information from the information;
inputting the modified information into a machine learning model; and
generating, using the machine learning model, a second description of the product using the modified information, the machine learning model configured to generate the second description to conform with one or more characteristics.
